(19) United States
(12) Patent Application Publication
(10) Pub. No.: US 2024/0167218 A1
(43) Pub. Date: May 23, 2024

(54) GRAPHENE COATED FABRIC, METHOD OF PREPARING GRAPHENE COATED FABRIC, AND APPLICATIONS THEREOF

(71) Applicant: RELIANCE INDUSTRIES LIMITED, Mumbai (IN)

(72) Inventors: Joseph Berkmans AMIRTHASAMY, Sivaganga (IN); Vivek Prabhakar RAJE, Thane (IN); Mahesh Chandra SHARMA, Navi Mumbai (IN); Kaustav GOSWAMI, Kolkata (IN)

(21) Appl. No.: 18/549,765

(22) PCT Filed: Mar. 10, 2022
(86) PCT No.: PCT/IB2022/052150

§ 371 Date: Sep. 8, 2023

(30) Foreign Application Priority Data
Mar. 11, 2021 (IN) 202121010362

(51) Int. Cl. D06M 11/74; D06M 23/10; D06P 1/673

(52) U.S. Cl. CPC D06M 11/74; D06M 23/10; D06P 1/673; D10B 2401/13; D10B 2401/16

(57) ABSTRACT

Graphene coated fabrics including graphene and/or its derivative(s) at very low concentrations, preferably between 0.0001 to 1 wt %, wherein the graphene coated fabric is characterized by one or more features, preferably at least two, at least three, at least four or all features selected from anti-microbial, antistatic, wicking, thermal cooling, anti-odour, and ultraviolet protection. In particular, a fabric coated with graphene at an amount ranging from about 0.0001% (w/w) to 1% (w/w), wherein the graphene is a combination of single layer graphene and multilayer graphene, and wherein the graphene has a surface area of about 300 m²/g to 800 m²/g.

### TECHNICAL FIELD

The present disclosure generally relates to the field of textile technology and graphene coatings. The disclosure relates to graphene coated fabrics possessing features selected from anti-microbial, antistatic, wicking, thermal cooling, anti-odour, ultraviolet (UV) protection, or combinations thereof. More particularly, the present disclosure relates to fabrics ‘coated’ with graphene and/or its derivative(s), wherein said graphene ‘coated’ fabrics are characterized by features selected from anti-microbial, antistatic, wicking, thermal cooling, anti-odour, ultraviolet (UV) protection, or combinations thereof.

### BACKGROUND OF THE DISCLOSURE

Fabrics (synthetic, natural and their blends) such as polyester are widely used as garment materials, sports wears, apparels in hospitals, medical devices, air purifiers and auto motive textile applications due to its high tenacity and durability. However, virgin fabrics have tendency to absorb moisture and grow microorganisms such as bacteria, virus and fungi on their surface and don't have any inherent ability to hamper the growth of microorganisms. The pathogenic effects are caused by many gram positive and gram negative bacterial species, most importantly Staphylococcus aureus, Klebsiella pneumonia, and Escherichia coli. These microorganisms cause adverse effects to the textiles and the consumers. Many anti-microbial agents and their use in preparing anti-microbial textiles are known. For instance, employing antimicrobial compounds such as quaternary ammonium salts, polyhexamethylene biguanide, triclosan, chitosan, dyes, regenerable N-halamine compounds and peroxyacids, or antimicrobial feature achieved by introducing physical modification on the fibers are known. Silver nanoparticles are the most effective and widely studied antimicrobial agent for textile applications. However, the costs and the release of the above mentioned compounds/metallic or silver nanoparticles to the environment are the biggest challenges. Chitosan is another naturally available agent used commonly for the antimicrobial finish, which is primarily used for antimicrobial finishing in cotton fabrics. Cotton fabrics are primarily treated with cross linking agents to create a chemical linkage between the fabric structure and the chitosan. However, this antimicrobial property is temporary and diminishes after washing.

Static charge build-up on clothing, carpeting and other textile products is a long recognized problem for textile manufacturer and consumers. Usually, metallic fiber of stainless steel is blended with synthetic fibers for preparing antistatic fabric. There are various other additives used at the finishing stage to impart antistatic property to the fabric, for example, organic amines and amides, polyhydridic alcohols, esters of salts of alkylphosphonium acids, betaine amphoteric surfactant, polyethylene glycol fatty acid ester etc. Such additives, however suffer from lack of durability and get washed away during repeated washing cycles. Alternatively, the filaments are also known to be treated with antistatic finish but it is found to be lost in subsequent processing steps involving mechanical handling, heating, washing and dyeing.

Further, developing fabrics that provide a cooling sensation when worn and touched is a growing need in textile industry. Efforts to develop such fabric includes infusion of thermal conductive filler into the fiber, introduction of resin containing hydrophilic groups during the manufacturing of fiber, treating the fiber with functional additive(s) etc. Multilayer fibers have been obtained by melt spinning of polyacetal copolymer and thermoplastic resin, where the polyacetal copolymer resides on the surface and provides cool touch effect. However, in many cases, the final fabric does not reveal significant cool touch effect when it is actually subjected to a sensory test in human. In most of the cases, in order to achieve sufficient cool contact effect, it is required to use large quantity of additives and that leads to compromising of texture and touch feel effect of the fabric. Additionally, the thermal cooling property obtained is temporary and diminishes after washing.

Moisture wicking property is also a desired feature for a fabric and is mostly employed in leisure wear industry. Synthetic fabrics owing to its hydrophilic property possess poor wicking feature and that causes physical irritation to the wearer. Synthetic fiber, yarn or fabric are treated with various hydrophilic agents in order to achieve wicking feature. Synthetic fibers are treated with caustic soda in order to generate carboxyl groups on the surface of synthetic polymer and thereby modifying the wicking feature. However, this process is difficult to control and also does not demonstrate sufficient improvement. Further, most of the finishing agents/additives used to improve wicking nature of the fabric suffer from poor durability owing to their hydrophilic nature.

In addition, to protect the human skin from sunlight, particularly UV radiation, there is an urgent need for development of fabrics with UV blocking feature. UV resistant additives can be introduced in various stages of fiber, yarn and fabric manufacturing/processing steps. Widely used UV screening additives are benzophenone compounds, triazole compounds, benzoic acid compounds, zinc oxide, titanium oxide etc. However, the organic reflecting agents suffer from potential toxicity and inorganic blocking agents impart inferior stability and inadequate efficiency.

Taken together, there is a requirement for fabrics possessing one or more features as discussed above, more importantly, said features existing simultaneously without interfering with each other. The present disclosure tries to address said need.

### SUMMARY OF THE DISCLOSURE

Addressing the aforesaid need in the art, the present disclosure provides a fabric ‘coated’ with graphene at very low amounts to obtain a graphene coated fabric characterized by features selected from antimicrobial, antistatic, anti-odour, wicking, thermal cooling, ultraviolet (UV) protection, or any combination of features thereof.

Particularly, the disclosure provides a fabric ‘coated’ with graphene at an amount ranging from about 0.0001% (w/w) to 1% (w/w), wherein the graphene is a combination of single layer graphene and multilayer graphene, wherein the graphene has a surface area of about 300 m²g to 800 m²g, and said fabric is characterized by features selected from antimicrobial, antistatic, anti-odor, wicking, thermal cooling, ultraviolet (UV) protection, or any combination of features thereof.

In some embodiments, the graphene in the graphene coated fabric of the present disclosure comprises about 80% to about 85% single layer graphene and about 15% to about 20% multilayer graphene. In some embodiments, the multilayer graphene comprises two layer graphene, three layer graphene, four layer graphene, five layer graphene or any combination thereof.

In some embodiments, the graphene in the graphene coated fabric of the present disclosure comprises about 80% to about 85% single layer graphene and about 15% to about 20% of two to five layered graphene.

In some embodiments, the graphene in the graphene coated fabric of the present disclosure comprises about 80%, about 81%, about 82%, about 83%, about 84% or about 85% of the single layer graphene.

In some embodiments, the graphene in the graphene coated fabric of the present disclosure comprises about 15%, about 16%, about 17%, about 18%, about 19% or about 20% of the multilayer graphene.

In some embodiments, the graphene has a surface area ranging from about 300 m²g to about 800 m²g.

In some embodiments, the graphene has surface area of about 300 m²g, about 350 m²g, about 400 m²g, about 450 m²g, about 500 m²g, about 550 m²g about 600 m²g, about 650 m²g, about 700 m²g, about 750 m²g or about 800 m²g.

In some embodiments, the graphene is present at an amount ranging from about 0.0001% to 1% (w/w), or 0.0001% (w/w) to 0.01% (w/w), or about 0.0001% (w/w) to 0.004% (w/w).

In some embodiments, the graphene is present in the fabric in the form of a coat on the surface of the fabric.

In some embodiments, the fabric is selected from the group comprising natural fabric, synthetic fabric, a blend of natural fabric and synthetic fabric, and combinations thereof; and the graphene is a graphene, a graphene derivative or a combination thereof.

In some embodiments, the fabric is a cotton fabric.

In some embodiments, the fabric is a cotton polyester blend.

In some embodiments, the graphene coated fabric is characterized by one or more, or a combination of at least two, at least three, at least four or at least five features selected from antimicrobial, antistatic, anti-odour, wicking, thermal cooling and ultraviolet protection.

In some embodiments, the graphene coated fabric is characterized by an increase of 1 fold to 10 fold of antimicrobial, antistatic, anti-odour, wicking, thermal cooling and ultraviolet protection when compared to a fabric lacking the combination of single layer graphene and multilayer graphene or a fabric lacking the combination of single layer graphene and multilayer graphene and a surface area of about 300 m²g to 800 m²g.

In some embodiments, the graphene coated fabric of the present disclosure comprises bactericidal or antibacterial effect, bacteriostatic effect, antiviral effect, antifungal effect or combinations thereof. In some embodiments, the graphene coated fabric is characterized by a bactericidal effect ranging from about 90% to 99.999% against Staphylococcus aureus, Klebsiella pneumonia, and Escherichia coli. In some embodiments, the graphene coated fabric is characterized by a bacteriostatic effect ranging from about 90% to 99.999% against Staphylococcus aureus, Klebsiella pneumonia, and Escherichia coli. In some embodiments, the graphene coated fabric is characterized by an antiviral effect ranging from about 90% to 99.999% against MS2 bacteriophage. In some embodiments, the graphene coated fabric is characterized by an antifungal effect ranging from about 90% to 99.999% against Aspergillus Niger and Candida Albicans.

In some embodiments, the graphene coated fabric is characterized by half decay time for discharge of charge applied on the fabric surface which ranges from about 0.1 seconds to 3 seconds.

In some embodiments, the graphene coated fabric is characterized by half decay time for discharge of charge applied on the fabric surface at 25° C. and 45% relative humidity ranging from about 0.1 seconds to 3 seconds.

In some embodiments, the anti-odour effect is measured by AATCC 100 standard which ranges from about 90% to 99.999%.

In some embodiments, the wicking effect is measured by AATCC 197:2013 standard which ranges from about 2 inches to 5 inches in 3 minutes to about 5 inches to 10 inches in 30 minutes.

In some embodiments, the present graphene coated fabric provides a sensation of instantaneous thermal cooling whenever there is initial contact of the fabric with the skin surface. In some embodiments, the thermal cooling is measured by Q-Max which ranges from about 0.1 watts per square centimeter (W/cm²) to 0.7 W/cm².

In some embodiments, the ultraviolet (UV) protection measured by ultraviolet protection factor (UPF) ranges from about 30 to 70.

In some embodiments, the present graphene coated fabric has a washing fastness, perspiration fastness, sublimation fastness and light fastness of about 4 to 5.

In some embodiments, the present graphene coated fabric has water absorbency of 0.1 Sec to 5 Sec.

The present disclosure further provides a method of preparing a fabric comprising graphene as described above characterized by features selected from antimicrobial, antistatic, anti-odour, wicking, thermal cooling, ultraviolet (UV) protection, or any combination of features thereof, comprising:
a) preparing a graphene slurry by dispersing graphene in a solvent and optionally a surfactant, followed by mixing to obtain the graphene slurry,
b) mixing the graphene slurry with a dyeing solution to obtain a coating composition, wherein the dyeing solution comprises a disperse dye, a reactive dye, a migration inhibitor, a wetting agent, dispersing agent, sodium bicarbonate and urea, and
c) coating a fabric with the coating composition, to prepare the fabric comprising graphene,
   wherein the fabric comprises graphene at an amount ranging from about 0.0001% (w/w) to 1% (w/w);
   wherein the graphene is a combination of single layer graphene and multilayer graphene;
   and wherein the graphene has a surface area of about 300 m²g to 800 m²g

In some embodiments of the method of the present disclosure, the graphene comprises about 80% to 85% of the single layer graphene and about 15% to 20% of the multilayer graphene.

In some embodiments of the method of the present disclosure, the method comprises:
a) preparing a graphene slurry by dispersing graphene in water and optionally a surfactant selected from a group comprising polyvinyl pyrrolidone (PVP), sodium dodecyl sulfate (SDS), sodium lauryl sulfate (SLS), sodium lauryl ether sulfate (SLES), silicon and combinations thereof, followed by mixing to obtain the graphene slurry,
b) mixing the graphene slurry with a dyeing solution to obtain a coating composition, wherein the dyeing solution comprises a disperse dye, a reactive dye, a migration inhibitor, a wetting agent, dispersing agent, sodium bicarbonate and urea, and
c) coating a fabric with the coating composition to prepare the fabric comprising graphene.

In some embodiments of the method of the present disclosure, the method comprises:
a) preparing the graphene slurry by dispersing graphene in water and mixing for about 3 hours in a high shear mixer,
   or adding polyvinyl pyrrolidone to water and mixing for about 15 minutes at 6000 rpm, followed by dispersing graphene and mixing for about 3 hours in a high shear mixer to prepare the graphene slurry,
b) diluting the graphene slurry with water and filtering through a mesh filter, followed by mixing the graphene slurry with a dyeing solution to obtain a coating composition, wherein the dyeing solution comprises a disperse dye, a reactive dye, a migration inhibitor, a wetting agent, dispersing agent, sodium bicarbonate and urea,
c) coating the fabric with the coating composition by a dyeing technique selected from the group comprising jigger dyeing, winch dyeing, beam dyeing, padding, pad batch, pad steam, pad dry, thermosol dyeing, soft flow, exhaust dyeing, foam coating and combinations thereof, to prepare the fabric comprising graphene,
d) subjecting the fabric coated with coating composition to drying, wherein the drying comprises an initial partial drying in an infra-red pre dryer, followed by final drying between 60° C. to 80° C., and
e) thermo-fixation of the fabric at about 110° C. to 140° C.

In some embodiments, the method of preparing the graphene coated fabric of the present disclosure comprises:
a) preparing the graphene slurry, wherein graphene is present in an amount of about 0.0001% to 7% (w/w);
b) preparing a dyeing solution comprising disperse dye, a reactive dye, a migration inhibitor, a wetting agent, dispersing agent, sodium bicarbonate and urea; and
c) coating a fabric with the graphene slurry of step a) and the dyeing solution of step b) to prepare the graphene coated fabric comprising graphene at an amount ranging from about 0.0001% (w/w) to 1% (w/w); wherein the graphene is a combination of single layer graphene and multilayer graphene; wherein the graphene has a surface area of about 300 m²g to 800 m²g; and said fabric is characterized by the combination of at least two features, at least three features, at least four features or all features selected from anti-microbial, antistatic, anti-odour, wicking, thermal cooling and ultraviolet protection.

As mentioned in this disclosure, the concentration of graphene within the graphene slurry prepared herein ranges from about 0.0001 wt % to about 7 wt %. Accordingly, in some embodiments, any of the said concentration values ranging from about 0.0001 wt % to about 7 wt % comprises about 80% to about 85% of single layered graphene, and about 15% to about 20% multi-layered graphene, wherein the multi-layered graphene is made up of about 2 to about 5 layers of graphene. Hence, for example, if the concentration of graphene within the slurry is about 2 wt %, about 80% to about 85% of this 2 wt % is made up of single layered graphene, and about 15% to about 20% of this 2 wt % is made up of multi-layered graphene, wherein the multi-layered graphene is made up of about 2 to about 5 layers of graphene.

In some embodiments, the mixing in above steps a) and/or b) is high shear mixing. In some embodiments, the mixing in above steps a) and/or b) is caried out in a high shear mixer.

In some embodiments, the solvent is selected from a group comprising water, alcohol, hydrocarbon, organic solvents, inorganic solvents and combinations thereof.

In some embodiments, the surfactant is selected a group comprising polyvinylpyrrolidone (PVP), sodium dodecyl sulfate (SDS), sodium lauryl sulfate (SLS), sodium lauryl ether sulfate (SLES), silicon and combinations thereof.

In some embodiments, the mixing in above steps a) or b) may be conducted by any method routinely practiced in the art that serves the purpose of combining the components.

In exemplary embodiments, the mixing in above step a) is carried out at a mixing rate of about 100 RPM to 10,000 RPM, including all values and ranges therefrom. In some embodiments, the mixing of the graphene slurry and the dyeing solution in step b) is carried out at a mixing rate of about 100 RPM to 1000 RPM, including all values and ranges therefrom.

The present disclosure also provides for a coating composition for preparing the fabric comprising graphene as described above, comprising: graphene, a solvent and optionally a surfactant, a disperse dye, a reactive dye, a migration inhibitor, a wetting agent, dispersing agent, sodium bicarbonate, and urea; wherein the graphene is a combination of single layer graphene and multilayer graphene; and wherein the graphene has a surface area of about 300 m²g to 800 m²g.

In some embodiments, the coating composition comprises of the following—
graphene present in an amount of about 0.0001% to 7% (w/w), including all values or ranges derivable therefrom;
a solvent,
optionally, a surfactant present in an amount of about 0.001% to 1% (w/w), including all values or ranges derivable therefrom,
the disperse dye present in an amount of about 0.1% to 10% (w/w), including all values or ranges derivable therefrom;
the reactive dye present in an amount of about 0.1% to 10% (w/w), including all values or ranges derivable therefrom;
the migration inhibitor present in an amount of about 0.1% to 2% (w/w), including all values or ranges derivable therefrom;
the wetting agent present in an amount of about 0.1% to 5% (w/w), including all values or ranges derivable therefrom;
the dispersing agent present in an amount of about 0.5% to 5% (w/w), including all values or ranges derivable therefrom;
sodium bicarbonate; and
urea;
wherein the graphene is a combination of single layer graphene and multilayer graphene;
and wherein the graphene has a surface area of about 300 m²g to 800 m²g.

In some embodiments, the graphene coating composition comprises graphene at a concentration of about 0.0001 wt % to 7 wt %, wherein about 80% to about 85% of said graphene is single layer graphene, and about 15% to about 20% of said graphene is multilayer graphene, and wherein the multi-layer graphene comprises of about 2 to about 5 layers of graphene.

In some embodiments, the graphene coating composition comprises graphene at a concentration of about 0.0001 wt %, 0.001 wt %, 0.01 wt %, 0.1 wt %, about 0.5%, about 1 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt % or about 7 wt %, wherein about 80% to about 85% of said graphene is single layer graphene, and about 15% to about 20% of said graphene is multilayer graphene, and wherein the multi-layered graphene comprises of about 2 to about 5 layers of graphene.

The present disclosure also relates to a kit for preparing the graphene coated fabric as described above, comprising:
a graphene slurry comprising graphene, solvent and optionally, a surfactant; and
a dyeing solution comprising a disperse dye, a reactive dye, a migration inhibitor, a wetting agent, dispersing agent, sodium bicarbonate and urea;
   wherein the graphene is a combination of single layer graphene and multilayer graphene, and wherein the graphene has a surface area of about 300 m²g to 800 m²g.

In some embodiments, the kit for preparing the graphene coated fabric as described above, comprises:
a graphene slurry comprising graphene, solvent and optionally, a surfactant, and
a dyeing solution comprising a disperse dye, a reactive dye, a migration inhibitor, a wetting agent, dispersing agent, sodium bicarbonate and urea,
   wherein the graphene is a combination of single layer graphene and multilayer graphene, wherein about 80% of the graphene is a single layer graphene and about 20% is a multilayer graphene, and wherein the graphene has a surface area of about 300 m²g to 800 m²g.

The present disclosure also relates to a dyeing solution for preparing the coating composition as described above, comprising: a disperse dye, a reactive dye, a migration inhibitor, a wetting agent, a dispersing agent, sodium bicarbonate, and urea.

### DETAILED DESCRIPTION OF THE DISCLOSURE

In view of the limitations discussed above, and to remedy the need in the art for fabric products characterized by one or more features selected from anti-microbial, anti-static, anti-odour, wicking, thermal cooling and ultraviolet protection, the present disclosure aims to provide a graphene coated fabric wherein graphene is present/employed at very low concentrations. In particular, the present disclosure relates to a fabric coated with graphene and/or its derivatives at very low concentrations. Said coating results in the graphene being incorporated on the surface of the fabric or may be internally infused or absorbed into the fabric. The disclosure also provides a corresponding process for preparing such graphene coated fabric product and corresponding beneficial features obtained thereof.

However, before describing the invention in greater detail, it is important to take note of the common terms and phrases that are employed throughout the present disclosure for better understanding of the technology provided herein.

Throughout the present disclosure, the term ‘graphene’ is intended to convey the ordinary conventional meaning of the term known to a person skilled in the art and intends to cover ‘graphene’ as an allotrope of carbon consisting of a single or multiple layers of carbon atoms. Thus, the graphene employed in the present disclosure may be a single layered or multi layered graphene. The graphene employed herein is preferably of a surface area, ranging between 300 m²/g to 800 m²/g. In non-limiting embodiments, the surface area of the graphene coated onto the fabric of the present disclosure is about 300 m²/g, 350 m²/g, 400 m²/g, 450 m²/g, 500 m²/g, 550 m²/g or 800 m²/g.

Throughout the present disclosure, the term ‘graphene derivatives’, ‘derivatives of graphene’ or the likes is intended to convey the ordinary conventional meaning of the term known to a person skilled in the art and intends to cover structural analogs of graphene, or compounds derived from graphene and having similar characteristics of graphene. In some embodiments of the disclosure, graphene derivatives encompass graphene nanoplatelets, graphene oxides, reduced graphene oxides, functionalized graphene, graphene decorated with metal particles, nanosized graphene, graphene quantum dots or any graphene containing material. However, in the context of the present disclosure, any derivative of graphene must in-turn be a combination of single and multi-layered graphene derivative and comprise about 80% to about 85% of single layered graphene derivative, and about 15% to about 20% multi-layered graphene derivative, wherein the multi-layered graphene derivative is made up of about 2 to about 5 layers of graphene.

Further, all references to graphene within the present disclosure also intends to cover its derivatives, unless explicitly stated otherwise. Thus, any embodiment of this disclosure referring to graphene is meant to be extrapolated to any derivative of graphene as well i.e., graphene can interchangeably mean derivative of graphene as well, unless explicitly stated otherwise.

In embodiments of the disclosure, graphene derivatives encompass functionalized graphene. Further, said term ‘functionalized’ or ‘functionalization’ is used interchangeably and is intended to convey the ordinary conventional meaning of the term known to a person skilled in the art in the field of polymer or material science, and intends to cover a process of adding new functions, features, capabilities, or properties to a material by changing the surface chemistry of the material. In the context of graphene employed in the present disclosure, the term is used to cover functionalization of graphene including reactions of graphene (and its derivatives) with organic and/or inorganic molecules, chemical modification of the graphene surface, and the interaction of various covalent and noncovalent components with graphene. The functionalization of graphene is surface modification used to reduce the cohesive force between the graphene sheets and to manipulate the physical and chemical properties of graphene.

Throughout the present disclosure, the terms ‘fabric’, ‘fibre’, ‘yam’, ‘textile’, ‘cloth’ or the likes are intended to convey the ordinary conventional meaning of the terms known to a person skilled in the art and intends to cover natural fabric, synthetic fabric and blends of natural and/or synthetic fabric. Further, ‘fabric’ encompasses unprocessed/virgin fabric and/or processed/partially processed fabric.

Throughout the present disclosure, the terms/phrases ‘graphene coated fabric’, ‘fabric comprising graphene‘ or’ graphene-containing fabric’ are used interchangeably and refer to the feature of fabric with graphene introduced/coated/impregnated onto it by a coating or dyeing technique.

As used herein, the phrase ‘coated with’ while referring to the fabric of the present disclosure coated with graphene refers to fabric, the surface of which is coated with graphene or derivatives thereof.

The term ‘anti-microbial’ and obvious variants thereof as used in the present disclosure, refers to the characteristic of the fabric of the present disclosure that exerts destructive or inhibitory effect on the growth of microorganisms, including bacteria, viruses, and fungi.

As used herein, the term ‘anti-bacterial’ refers to bacteriostatic or bactericidal activity of the fabric, wherein ‘bacteriostatic’ typically means that the agent prevents the growth of bacteria (i.e., it keeps them in the stationary phase of growth), and ‘bactericidal’ means that it kills bacteria. In reality, there are 2 pure categories of antimicrobial agents (one that exclusively kills bacteria and another that only inhibits growth). Most anti-bacterials are better described as potentially being both bactericidal and bacteriostatic.

As used herein, the term ‘anti-viral’ refers to the ability of the fabric to kill a virus or suppress its ability to replicate and, hence, inhibits its capability to multiply and reproduce.

As used herein, the term ‘anti-fungal’ refers to the ability of the fabric to limit or prevent the growth of yeasts and other fungal organisms.

The term ‘anti-static’ and obvious variants thereof refer to the characteristic of the fabric of the present disclosure typically relating to reduction or elimination of build-up of static electricity.

The term ‘wicking’ and obvious variants thereof refer to a technical feature of the fabric of the present disclosure which draws moisture away from the body.

The term ‘thermal cooling’ and obvious variants thereof refer to the characteristic of the fabric that allows thermal regulation due to the thermal conductivity of the fabric. Said feature allows body heat to pass through the fabric by conduction/convection to the ambient environment.

The term ‘UV protection’, ‘ultraviolet protection’ and obvious variants thereof refer to the protective effect exerted by the fabric against sun's ultraviolet (UV) radiation. Unless otherwise mentioned, Ultraviolet Protection Factor (UPF) is used as a measuring parameter of the ‘UV protection’ characteristic of the fabric.

‘Washing fastness’ refers to the ability of the fabric to maintain the original colour under the washing condition, that is, the ability of not fading and changing colour.

‘Rubbing fastness’ refers to the resistance to fading of dyed fabric when subjected to dry-rubbing or wet-rubbing. It is considered as a measure of colour fastness of fabric and is typically measured by use of crockmeter.

‘Perspiration fastness’ refers to the ability of the fabric to not fade and not stain when dyed fabric is perspired.

‘Sublimation fastness’ refers to the ability of high temperature resistance and colour fastness of the fabric under heat pressure or heat drum process.

‘Light fastness’ or ‘Lightfastness’ is the resistance of a colourant such as dye or pigment present in the fabric to fading when it is when exposed to light.

‘Blend’ it the context of the present disclosure refers to ‘blended fabric’ or a ‘fabric blend’, wherein said blended fabric is formed from fibres or yarn formed by combining fibres of different origins (synthetic/natural), length, thickness, or colour.

In the context of the present disclosure, the terms ‘coating’ and ‘dyeing’ have been used interchangeably to refer to the process feature of applying graphene to the fabric to form the graphene coated fabric of the present disclosure.

The terms ‘coating composition’ and ‘graphene coating composition’ as referred to herein refer to the mixture of graphene slurry and dyeing solution coated onto the fabric of the present disclosure that comprises graphene and/or its derivatives optionally along with one or more components of dyeing solution as described herein.

Accordingly, the present disclosure relates to a graphene and/or graphene derivative coated fabric product comprising graphene and/or its derivatives at very low amounts, wherein said fabric is specifically characterized by features selected from anti-microbial, antistatic, anti-odour, wicking, thermal cooling, ultraviolet protection and combinations thereof.

Particularly provided by the present disclosure is a graphene coated fabric comprising graphene at an amount ranging from about 0.0001% (w/w) to 1% (w/w), said fabric characterized by one or more features selected from anti-microbial, antistatic, anti-odour, wicking, thermal cooling and ultraviolet protection.

More particularly, the present disclosure provides a fabric coated with graphene at an amount ranging from about 0.0001% (w/w) to 1% (w/w) with respect to the weight of the fabric, including all values or ranges derivable therefrom, wherein the graphene is a combination of single layer graphene and multilayer graphene, and has a surface area of about 300 m²g to 800 m²g.

In some embodiments, the graphene in the graphene coated fabric of the present disclosure comprises about 80% to about 85% single layer graphene and about 15% to about 20% multilayer graphene. In some embodiments, multilayer graphene comprises two layer graphene, three layer graphene, four layer graphene, five layer graphene or any combination thereof.

Single layer graphene is the pristine form of graphene having all the attributes in its highest form. However, obtaining 100% pure single layer graphene requires labor intensive processes and thus increases the cost. Moreover, 100% single layer graphene has extremely high surface area which makes it difficult to process. These drawbacks are overcome in the present disclosure by use of a graphene composition which is a combination of single and multilayered graphene and comprises about 80% to about 85% of single layered graphene, and about 15% to about 20% multilayered graphene, wherein the multilayered graphene is made up of about 2 to about 5 layers of graphene. Such a combination of graphene possesses all the required attributes for preparing the fabric of the present disclosure with surface areas that are optimum for processing. However, it is crucial to note that arriving at such a graphene combination that comprises both single and multi-layered graphene is not direct and straightforward. This is because the surface area of a graphene is inversely proportional to the number of layers present in the said graphene. When the number of layers increases, the available surface area decreases and vice versa. While a very low surface area (with high number of layers) is detrimental as it adversely impacts the resulting properties and outcome, a very high surface area also makes processing of the graphene so much more challenging and process intensive. Thus, a critical balance between the number of layers and the surface area of the selected graphene is required to achieve the desired results in the present disclosure.

As described above, the graphene employed in the present disclosure is a combination of single and multi-layered graphene and comprises about 80% to about 85% of single layered graphene, and about 15% to about 20% multi-layered graphene, wherein the multi-layered graphene is made up of about 2 to about 5 layers of graphene. This description of the graphene and its composition is fulfilled by the graphene that is employed to prepare the graphene slurry in the present disclosure, as well as by the graphene that is present in the final product, i.e., fabric comprising graphene.

As mentioned in this disclosure, the concentration of graphene coated on the fabric ranges from about 0.0001% (w/w) to about 1% (w/w) which is equivalent to about 1 ppm to about 10000 ppm. Accordingly, in some embodiments, any of the said amounts ranging from about 0.0001% (w/w) to about 1% (w/w) comprises about 80% to about 85% of single layered graphene, and about 15% to about 20% multi-layered graphene, wherein the multi-layered graphene is made up of about 2 to about 5 layers of graphene. Hence, for example, if the amount of graphene coated on to the fabric is about 0.01%, about 80% to about 85% of this 0.01% is made up of single layered graphene, and about 15% to about 20% of this 0.01% is made up of multi-layered graphene, wherein the multi-layered graphene is made up of about 2 to about 5 layers of graphene.

In some embodiments, the graphene in the graphene coated fabric of the present disclosure comprises about 80% to about 85% single layer graphene and about 15% to about 20% of two to five layered graphene.

In some embodiments, the graphene in the graphene coated fabric of the present disclosure comprises about 80%, about 81%, about 82%, about 83%, about 84% or about 85% of the single layer graphene.

In some embodiments, the graphene in the graphene coated fabric of the present disclosure comprises about 15%, about 16%, about 17%, about 18%, about 19% or about 20% multilayer graphene.

In some embodiments, the graphene in the graphene coated fabric of the present disclosure has a surface area ranging from about 300 m²g to about 800 m²g.

In some embodiments, the graphene has surface area of about 300 m²g, about 350 m²g, about 400 m²g, about 450 m²g, about 500 m²g, about 550 m²g, about 600 m²g, about 650 m²g, about 700 m²g, about 750 m²g, or about 800 m²g.

In some embodiments, the disclosure provides a fabric coated with graphene at an amount ranging from about 0.0001% (w/w) to 1% (w/w) with respect to the weight of the fabric, including all values or ranges derivable therefrom; and wherein the graphene is a combination of single layer graphene and multilayer graphene.

In some embodiments, the disclosure provides a fabric coated with graphene at an amount ranging from about 0.0001% (w/w) to 1% (w/w) with respect to the weight of the fabric, including all values or ranges derivable therefrom; wherein the graphene is a combination of single layer graphene and multilayer graphene; and wherein the graphene has a surface area of about 300 m²g to 800 m²g.

In some embodiments, the disclosure provides a fabric coated with graphene at an amount ranging from about 0.0001% (w/w) to 1% (w/w) with respect to the weight of the fabric, including all values or ranges derivable therefrom; wherein the graphene comprises about 80% to 85% (w/w) of the single layer graphene and about 15% to 20% (w/w) of the multilayer graphene; and wherein the graphene has a surface area of about 300 m²g to 800 m²g.

In some embodiments, the disclosure provides a fabric coated with graphene at an amount ranging from about 0.0001% (w/w) to 1% (w/w) with respect to the weight of the fabric, including all values or ranges derivable therefrom; wherein the graphene comprises about 80% (w/w) of the single layer graphene and about 20% (w/w) of the multilayer graphene; and wherein the graphene has a surface area of about 300 m²g to 800 m²g.

In some embodiments, the disclosure provides a fabric coated with graphene at an amount ranging from about 0.0001% (w/w) to 1% (w/w) with respect to the weight of the fabric, including all values or ranges derivable therefrom; wherein the graphene is a combination of single layer graphene and multilayer graphene; wherein the graphene comprises about 80% to 85% (w/w) of the single layer graphene and about 15% to 20% (w/w) of the multilayer graphene; and wherein the graphene has a surface area of about 400 m²g to 500 m²g.

In some embodiments, the disclosure provides a fabric coated with graphene at an amount ranging from about 0.0001% (w/w) to 1% (w/w) with respect to the weight of the fabric, including all values or ranges derivable therefrom; wherein the graphene is a combination of single layer graphene and multilayer graphene; wherein the graphene comprises about 80% (w/w) of the single layer graphene and about 20% (w/w) of the multilayer graphene; and wherein the graphene has a surface area of about 400 m²g to 500 m²g.

In some embodiments, the disclosure provides a fabric coated with graphene at an amount ranging from about 0.0001% (w/w) to 1% (w/w) with respect to the weight of the fabric, including all values or ranges derivable therefrom; wherein the graphene is a combination of 80% to 85% (w/w) single layer graphene and 15% to 20% (w/w) multilayer graphene; wherein the multilayer graphene comprises two to five layers of graphene, preferably two-layer graphene or three-layer graphene or a combination thereof, and wherein the graphene has a surface area of about 300 m²g to 800 m²g.

In some embodiments, the disclosure provides a fabric coated with graphene at an amount ranging from about 0.0001% (w/w) to 1% (w/w) with respect to the weight of the fabric, including all values or ranges derivable therefrom; wherein the graphene is a combination of single layer graphene and multilayer graphene; and wherein the graphene has a surface area of about 400 m²g to 500 m²g.

In some embodiments, the disclosure provides a fabric coated with graphene at an amount ranging from about 0.0001% (w/w) to 1% (w/w) with respect to the weight of the fabric, including all values or ranges derivable therefrom; wherein the graphene comprises about 80% to 85% (w/w) of the single layer graphene and about 15% to 20% (w/w) of the multilayer graphene, wherein the graphene has a surface area of about 400 m²g to 500 m²g.

In some embodiments, the disclosure provides a fabric coated with graphene at an amount ranging from about 0.0001% (w/w) to 1% (w/w) with respect to the weight of the fabric, including all values or ranges derivable therefrom; wherein the graphene comprises about 80% (w/w) of the single layer graphene and about 20% (w/w) of the multilayer graphene; and wherein the graphene has a surface area of about 400 m²g to 500 m²g.

In some embodiments, the disclosure provides a fabric coated with graphene at an amount ranging from about 0.0001% (w/w) to 1% (w/w) with respect to the weight of the fabric, including all values or ranges derivable therefrom, wherein the graphene is a combination of single layer graphene and multilayer graphene; wherein the graphene comprises about 80% to 85% (w/w) of the single layer graphene and about 15% to 20% (w/w) of the multilayer graphene; and wherein the multilayer graphene comprises two to five layers of graphene, preferably two-layer graphene or three-layer graphene or a combination thereof, wherein the graphene has a surface area of about 400 m²g to 500 m²g.

As defined above, the graphene-coated fabric of the present disclosure is further characterized by one or more features selected from anti-microbial, antistatic, anti-odour, wicking, thermal cooling and ultraviolet protection.

In some embodiments, the graphene coated fabric of the present disclosure comprises is characterized by a combination of at least two features selected from anti-microbial, antistatic, anti-odour, wicking, thermal cooling and ultraviolet protection.

In some embodiments, the graphene coated fabric of the present disclosure is characterized by a combination of at least three features selected from anti-microbial, antistatic, anti-odour, wicking, thermal cooling and ultraviolet protection.

In some embodiments, the graphene coated fabric of the present disclosure is characterized by a combination of at least four features selected from anti-microbial, antistatic, anti-odour, wicking, thermal cooling and ultraviolet protection.

In some embodiments, the graphene coated fabric of the present disclosure is characterized by a combination of all features—anti-microbial, antistatic, anti-odour, wicking, thermal cooling and ultraviolet protection.

In some embodiments, the present disclosure provides a graphene coated fabric having one or a combination of features as indicated in Table 1. In Table 1, X represents presence of the particular feature. Accordingly, every single feature or combination provided in Table 1 represents a separate embodiment of the present disclosure. However, the present disclosure also envisages a merger or mixture of these embodiments to provide for further possible combinations. Thus, for the purposes of the present disclosure, each of the feature/combination of features that are derivable from Table 1 below are envisaged to exist individually, all together or in different combinations within the ambit of the present disclosure.

TABLE 1

| | Graphene at | | | | | | |
|---|---|---|---|---|---|---|---|
| | an amount | | | | | | |
| | ranging | | | | | | |
| | from about | | | | | | |
| | 0.0001% | | | | | | |
| | (w/w) to | Anti- | Anti- | Anti- | | Thermal | Ultraviolet |
| Fabric | 1% (w/w) | microbial | static | odor | Wicking | cooling | protection |
| Polymer | X | X | X | X | | | |
| fabric A | | | | | | | |
| Polymer | X | X | X | | X | | |
| fabric B | | | | | | | |
| Polymer | X | X | X | | | X | |
| fabric C | | | | | | | |
| Polymer | X | X | X | | | | X |
| fabric D | | | | | | | |
| Polymer | X | X | | X | X | | |
| fabric E | | | | | | | |
| Polymer | X | X | | X | | X | |
| fabric F | | | | | | | |
| Polymer | X | X | | X | | | X |
| fabric G | | | | | | | |
| Polymer | X | X | | | X | X | |
| fabric H | | | | | | | |
| Polymer | X | X | | | X | | X |
| fabric I | | | | | | | |
| Polymer | X | X | | | | X | X |
| fabric J | | | | | | | |
| Polymer | X | X | X | X | X | | |
| fabric K | | | | | | | |
| Polymer | X | X | X | X | | X | |
| fabric L | | | | | | | |
| Polymer | X | X | X | X | | | X |
| fabric M | | | | | | | |
| Polymer | X | X | X | | X | X | |
| fabric N | | | | | | | |
| Polymer | X | X | X | | X | | X |
| fabric O | | | | | | | |
| Polymer | X | X | | X | X | X | |
| fabric P | | | | | | | |
| Polymer | X | X | | X | X | | X |
| fabric Q | | | | | | | |
| Polymer | X | X | | X | | X | X |
| fabric R | | | | | | | |
| Polymer | X | X | X | | | X | X |
| fabric S | | | | | | | |
| Polymer | X | X | | | X | X | X |
| fabric T | | | | | | | |
| Polymer | X | | X | X | X | X | |
| fabric U | | | | | | | |
| Polymer | X | | X | X | X | | X |
| fabric V | | | | | | | |
| Polymer | X | | X | X | | X | X |
| fabric W | | | | | | | |
| Polymer | X | | | X | X | X | X |
| fabric X | | | | | | | |
| Polymer | X | X | X | X | X | X | |
| fabric Y | | | | | | | |
| Polymer | X | | X | X | X | X | X |
| fabric Z | | | | | | | |
| Polymer | X | X | | X | X | X | X |
| fabric A′ | | | | | | | |
| Polymer | X | X | X | | X | X | X |
| fabric B′ | | | | | | | |
| Polymer | X | X | X | X | | X | X |
| fabric C′ | | | | | | | |
| Polymer | X | X | X | X | X | | X |
| fabric D′ | | | | | | | |
| Polymer | X | X | X | X | X | X | X |
| fabric E′ | | | | | | | |
| Polymer | X | X | | | | | |
| fabric F′ | | | | | | | |
| Polymer | X | | X | | | | |
| fabric G′ | | | | | | | |
| Polymer | X | | | X | | | |
| fabric H′ | | | | | | | |
| Polymer | X | | | | X | | |
| fabric I′ | | | | | | | |
| Polymer | X | | | | | X | |
| fabric J′ | | | | | | | |
| Polymer | X | | | | | | X |
| fabric K′ | | | | | | | |
| Polymer | X | X | X | | | | |
| fabric L′ | | | | | | | |
| Polymer | X | X | | X | | | |
| fabric M′ | | | | | | | |
| Polymer | X | X | | | X | | |
| fabric N′ | | | | | | | |
| Polymer | X | X | | | | X | |
| fabric O′ | | | | | | | |
| Polymer | X | X | | | | | X |
| fabric P′ | | | | | | | |
| Polymer | X | | X | X | | | |
| fabric R′ | | | | | | | |
| Polymer | X | | X | | X | | |
| fabric S′ | | | | | | | |
| Polymer | X | | X | | | X | |
| fabric T′ | | | | | | | |
| Polymer | X | | X | | | | X |
| fabric U′ | | | | | | | |
| Polymer | X | | | X | X | | |
| fabric W′ | | | | | | | |
| Polymer | X | | | X | | X | |
| fabric X′ | | | | | | | |
| Polymer | X | | | X | | | X |
| fabric Y′ | | | | | | | |
| Polymer | X | | | | X | X | |
| fabric Z′ | | | | | | | |
| Polymer | X | | | | X | | X |
| fabric A″ | | | | | | | |

As can be observed from the above, while the concentration of graphene coated onto the fabric remains between 0.00001% (w/w) to 1% (w/w) along with other structural features of graphene as described above, the further features of the fabric may vary with the restriction that one or more features selected from anti-microbial, antistatic, anti-odour, wicking, thermal cooling and ultraviolet protection are met. Each of the above features is further characterized by features such as but not limited to good/excellent washing fastness, rubbing fastness, perspiration fastness, sublimation fastness and light fastness.

In some embodiments, the graphene coated fabric of the present disclosure is characterized by an increase of about 1 fold to about 10 fold of anti-microbial, antistatic, anti-odour, wicking, thermal cooling and ultraviolet protection when compared to a fabric lacking graphene, said graphene being a combination of single layer graphene and multilayer graphene, or a fabric lacking graphene, said graphene being a combination of single layer graphene and multilayer graphene and having a surface area of about 300 m²g to 800 m²g.

In some embodiments, the graphene coated fabric of the present disclosure is characterized by at least two or more, three or more or four or more of the following—
about 1 fold to about 10 fold increase in anti-microbial activity;
about 1 fold to about 10 increase in antistatic activity;
about 1 fold to about 10 increase in anti-odour activity;
about 1 fold to about 10 increase in wicking efficiency;
about 1 fold to about 10 increase in thermal cooling; and
about 1 fold to about 10 increase in ultraviolet protection
when compared to a fabric lacking graphene, said graphene being a combination of single layer graphene and multilayer graphene, or a fabric lacking graphene, said graphene being a combination of single layer graphene and multilayer graphene and having a surface area of about 300 m²g to 800 m²g.

In some embodiments, the graphene coated fabric of the present disclosure is characterized by all of the following—
about 1 fold to about 10 fold increase in anti-microbial activity;
about 1 fold to about 10 increase in antistatic activity;
about 1 fold to about 10 increase in anti-odour activity;
about 1 fold to about 10 increase in wicking efficiency;
about 1 fold to about 10 increase in thermal cooling; and
about 1 fold to about 10 increase in ultraviolet protection
when compared to a fabric lacking graphene, said graphene being a combination of single layer graphene and multilayer graphene, or a fabric lacking graphene, said graphene being a combination of single layer graphene and multilayer graphene and having a surface area of about 300 m²g to 800 m²g.

In some embodiments, the graphene coated fabric of the present disclosure is characterized by an increase of about 1 fold, about 2 fold, about 3 fold, about 4 fold, about 5 fold, about 6 fold, about 7 fold, about 8 fold, about 9 fold or about 10 fold in anti-microbial, antistatic, anti-odour, wicking, thermal cooling and ultraviolet protection when compared to a fabric lacking graphene, said graphene being a combination of single layer graphene and multilayer graphene, or a fabric lacking graphene, said graphene being a combination of single layer graphene and multilayer graphene and having a surface area of about 300 m²g to 800 m²g.

In some embodiments, the anti-microbial activity comprises bactericidal or antibacterial effect, bacteriostatic effect, antiviral effect, antifungal effect or combinations thereof. In some embodiments, the graphene coated fabric is characterized by a bactericidal effect ranging from about 90% to 99.999%, including all values or ranges derivable therefrom, against Staphylococcus aureus, Klebsiella pneumonia, and Escherichia coli.

In exemplary embodiments, the graphene coated fabric is characterized by a bactericidal effect ranging from about 99.94% to 99.95%, including all values or ranges derivable therefrom, against Staphylococcus aureus, Klebsiella pneumonia, and Escherichia coli.

In some embodiments, the graphene coated fabric is characterized by a bacteriostatic effect ranging from about 90% to 99.999%, including all values or ranges derivable therefrom, against Staphylococcus aureus, Klebsiella pneumonia, and Escherichia coli.

In some embodiments, the graphene coated fabric is characterized by a bacteriostatic effect ranging from about 99% to 99.999%, including all values or ranges derivable therefrom, against Staphylococcus aureus, Klebsiella pneumonia, and Escherichia coli.

In some embodiments, the graphene coated fabric is characterized by a bacteriostatic effect comprising log reduction of bacterial value ranging from about 3 to 5, including all values or ranges derivable therefrom, against Staphylococcus aureus, Klebsiella pneumonia, and Escherichia coli. In exemplary embodiments, the fabric is characterized by a bacteriostatic effect comprising log reduction of bacterial value ranging from about 3.25 to 4.22, against Staphylococcus aureus, Klebsiella pneumonia, and Escherichia coli.

In some embodiments, the graphene coated fabric is characterized by an antiviral effect ranging from about 90% to 99.999%, including all values or ranges derivable therefrom, against M2 bacteriophage.

In some embodiments, the graphene coated fabric is characterized by an antiviral effect ranging from about 99.9% to 99.999%, including all values or ranges derivable therefrom, against M2 bacteriophage.

In some embodiments, the graphene coated fabric is characterized by an antiviral effect comprising a log reduction of virus value ranging from about 3 to 4 against M2 bacteriophage. In exemplary embodiments, the graphene coated fabric is characterized by an antiviral effect comprising a log reduction of virus value ranging from about 3.66 to 3.93 against M2 bacteriophage.

In some embodiments, the graphene coated fabric is characterized by an antifungal effect ranging from about 90% to 99.999%, including all values or ranges derivable therefrom, against Aspergillus niger and Candida albicans.

In exemplary embodiments, the graphene coated fabric is characterized by an antifungal effect ranging from about 99.70% to 99.99% against Aspergillus niger and Candida albicans.

In some embodiments, the graphene coated fabric is characterized by antistatic effect measured by half decay time for discharge of charge applied on the fabric surface which ranges from about 0.1 seconds to 3 seconds, including all values or ranges derivable therefrom. In some embodiments, the static discharge half decay time of the graphene incorporated fabric at a temperature of about 25° C. and at about 45% relative humidity ranges from about 0.5 seconds to 3 seconds.

In some embodiments, the graphene coated fabric is characterized by anti-odour effect measured by AATCC 100 standard which ranges from about 90% to 99.999%, including all values or ranges derivable therefrom.

In some embodiments, the graphene coated fabric is characterized by wicking effect measured by AATCC 197:2013 standard which ranges from about 2 inches to 5 inches/3 minutes to about 5 inches to 10 inches/30 minutes, including all values or ranges derivable therefrom.

In some embodiments, the graphene coated fabric is characterized by thermal cooling measured by Q-Max which ranges from about 0.1 watts per square centimeter (W/cm²) to 0.7 W/cm², including all values or ranges derivable therefrom.

In some embodiments, the graphene coated fabric is characterized by ultraviolet protection measured by ultraviolet protection factor (UPF) which ranges from about 30 to 70, including all values or ranges derivable therefrom.

In some embodiments, the graphene coated fabric of the present disclosure has washing fastness, perspiration fastness, sublimation fastness and light fastness of about 4 to 5 as measured on a standard rating scale wherein 1—is very poor, 2-3 is good, 3-4 is very good and 4-5 is excellent.

In some embodiments, the graphene coated fabric of the present disclosure has water absorbency of about 0.1 seconds to about 5 seconds, including all values or ranges derivable therefrom.

In some embodiments, the anti-microbial, antistatic, anti-odour, wicking, thermal cooling and ultraviolet protection features of the graphene coated fabric of the present disclosure are maintained after 30 washes or more. In some embodiments, the anti-microbial, antistatic, anti-odour, wicking, thermal cooling and ultraviolet protection features of the graphene coated fabric of the present disclosure are maintained even after at least 50 washes of the fabric. In some embodiments, the anti-microbial, antistatic, anti-odour, wicking, thermal cooling and ultraviolet protection features of the graphene coated fabric of the present disclosure are maintained until the entire life of the fabric.

In the graphene coated fabric of the present disclosure, the graphene is a graphene, a graphene derivative or a combination thereof, wherein said graphene or graphene derivative fulfils the requirement of being a combination of single layer graphene/graphene derivative and multilayer graphene/graphene derivative and having a surface area of 300 m²g to 800 m²g. Further, all references to graphene in the present disclosure also intends to cover its derivatives. Thus, all embodiments referring to graphene is meant to be extrapolated to any derivative of graphene as well.

In some embodiments of the present disclosure, the graphene coated fabric comprises graphene and/or its derivatives at a concentration ranging from about 0.0001% (w/w) to less than 0.005% (w/w), including all values or ranges therefrom.

In some embodiments of the present disclosure, the graphene coated fabric comprises graphene and/or its derivatives at a concentration ranging from about 0.0001% (w/w) to 0.004% (w/w), including all values or ranges therefrom.

In some embodiments of the present disclosure, the graphene coated fabric comprises graphene and/or its derivatives at a concentration ranging from about 0.0001% (w/w) to 0.2% (w/w).

In a non-limiting embodiment, the graphene coated fabric comprises graphene and/or its derivatives at a concentration of about 0.0001% (w/w), about 0.00015% (w/w), about 0.0002% (w/w), about 0.00025% (w/w), about 0.0003% (w/w), about 0.00035% (w/w), about 0.0004% (w/w), about 0.00045% (w/w), about 0.0005% (w/w), about 0.00055% (w/w), about 0.0006% (w/w), about 0.00065% (w/w), about 0.0007% (w/w), about 0.00075% (w/w), about 0.0008% (w/w), about 0.00085% (w/w), about 0.0009% (w/w), about 0.00095% (w/w), about 0.001% (w/w), about 0.0015% (w/w), about 0.002% (w/w), about 0.0025% (w/w), about 0.003% (w/w), about 0.0035% (w/w), about 0.004% (w/w), about 0.0045% (w/w), about 0.0049% (w/w), about 0.005% (w/w), about 0.0055% (w/w), about 0.006% (w/w), about 0.0065% (w/w), about 0.007% (w/w), about 0.0075% (w/w), about 0.008% (w/w), about 0.0085% (w/w), about 0.009% (w/w), about 0.0095% (w/w), about 0.01% (w/w), about 0.015% (w/w), about 0.02% (w/w), about 0.025% (w/w), about 0.03% (w/w), about 0.035% (w/w), about 0.04% (w/w), about 0.045% (w/w), about 0.05% (w/w), about 0.055% (w/w), about 0.06% (w/w), about 0.065% (w/w), about 0.07% (w/w), about 0.075% (w/w), about 0.08% (w/w), about 0.085% (w/w), about 0.09% (w/w), about 0.095% (w/w), about 0.1% (w/w), about 0.15% (w/w), about 0.2% (w/w), about 0.25% (w/w), about 0.3% (w/w), about 0.35% (w/w), about 0.40% (w/w), about 0.45% (w/w), about 0.5% (w/w), about 0.55% (w/w), about 0.6% (w/w), about 0.65% (w/w), about 0.7% (w/w), about 0.75% (w/w), about 0.8% (w/w), about 0.85%, about 0.9% (w/w), about 0.95% (w/w) or about 1% (w/w).

In embodiments of the present disclosure, the graphene derivatives are selected from a group comprising graphene nanoplatelets, graphene oxides, reduced graphene oxides, functionalized graphene, graphene decorated with metal particles, nanosized graphene, graphene quantum dots, any graphene containing material, and combinations thereof. In embodiments of the present disclosure, the graphene coated fabric product is a coated or dyed fabric product obtained after subjecting the fabric to coating or dyeing technique(s).

In embodiments of the present disclosure, the fabric is selected from a group comprising natural fabric, synthetic fabric, blend of natural fabric and synthetic fabric, and combinations thereof.

In embodiments of the present disclosure, the natural fabric is selected from a group comprising fabric derived from Alpaca, Angora wool, Azlon, Byssus, Camel hair, Cashmere wool, Chiengora, Lambswool, Llama, Mohair wool, Qiviut, Rabbit, Silk, Vicuña, Wool, Yak, Abacá, Acetate, Bamboo, Banana, Kapok, Coir, Cotton, Flax, Hemp, Jute, Kenaf, Lyocell, Modal, Piña, Raffia, Ramie, Rayon, Sisal, Soy protein and combinations thereof.

In embodiments of the present disclosure, the synthetic fabric is selected from a group comprising Acetate, Acrylic, Lyocell, Modacrylic, Microfibre, Nomex, Nylon, Polyester, Polypropylene, Polyvinyl chloride, Rayon/Viscose, Spandex, Kevlar and combinations thereof.

In embodiments of the present disclosure, the blended fabric is a fabric derived from any combination of materials selected from a group comprising Alpaca, Angora wool, Azlon, Byssus, Camel hair, Cashmere wool, Chiengora, Lambswool, Llama, Mohair wool, Qiviut, Rabbit, Silk, Vicuña, Wool, Yak, Abacá, Acetate, Bamboo, Banana, Kapok, Coir, Cotton, Flax, Hemp, Jute, Kenaf, Lyocell, Modal, Piña, Raffia, Ramie, Rayon, Sisal, Soy protein, Acetate, Acrylic, Lyocell, Modacrylic, Microfibre, Nomex, Nylon, Polyester, Polypropylene, Polyvinyl chloride, Rayon/Viscose, Spandex and Kevlar.

In some embodiments, the fabric is a cotton fabric.

In some embodiments, the fabric is a cotton polyester blend.

In another embodiment, the graphene is coated onto the fabric in the form of a coat on the surface of the fabric.

In some embodiments, the graphene when coated on the fabric forms physical bonding with fabric.

In some embodiments, the graphene when coated on the fabric forms chemical bond(s) with the fabric.

In embodiments of the present disclosure, graphene which is an atom thick honeycomb lattice of carbon possess extraordinary anti-microbial properties along with mechanical, thermal, electrical properties. Based on the number of stacking of layers in each entity, the graphene is classified as monolayer, bi-layer, tri-layer (multilayer) etc. The physical structure and chemically functionalized groups of the graphene has the ability to kill and control the growth of microorganisms and therefore provides anti-bacterial activity to graphene. The atom thick sheets of carbon have sharp edges and spikes that act as a sharp knife which cause irreversible damages to the cell membranes of the bacteria and kills them. Additionally, in another mechanism, the bacteria/microbes are wrapped by large sheets of graphene and get killed. The functionalized groups of graphene react chemically with the anti-oxidant groups of the bacteria (GSH-glutathione) in the cell membrane that oxidises said anti-oxidant groups of bacteria and induces oxidative stress which kill the bacteria. Accordingly, due to the above mechanisms and the synergetic effect of physical and chemical destructions to the cell membranes of bacteria, the graphene of the present disclosure which includes a combination of single layer (about 80-85%) and multilayer (about 15-20%) graphene and having a surface area of about 300 m²g to 800 m²g is a strong antibacterial/anti-microbial agent and provide better/improved antibacterial/anti-microbial activity compared to the currently available anti-microbial agents.

In addition to the above, the atom thick honey-comb carbon based lattice structure of graphene possesses extraordinary electrical properties due to overlapping of π-orbitals. The in-plane electrical conductivity of monolayer graphene is about 1×10⁻⁶ ohm·cm with an electron mobility of about 200000 cm²/Vs. Coating graphene onto fabrics greatly enhances the electrical conductivity and thus improves the anti-static property of the fabrics. Accordingly, due to the above properties of present graphene, more efficient and durable anti-static properties is conferred to fabrics as compared to the currently available anti-static agents. In some embodiments, coating of subtle/very low quantity of present graphene into fabrics, for instance at least about 0.0001 wt % or 0.01 wt % with respect to the weight of the fabric [grams per square metre (GSM) of fabric], particularly a fabric having GSM ranging from about 50 GSM to 500 GSM, effectively reduces resistivity of the fabric from about 1016 ohm·cm to less than about 109 ohm·cm, allowing for quick dissipation of charges from the fabric surface, thus leading to anti-static property of the treated fabric. This helps prevent build-up of static electricity in the fabric and helps overcome triboelectric effect arising from rubbing of the fabric. Anti-static agents typically employed in the art increase the electrical conductivity of the fabric by forming hygroscopic intermediate layers on the fabric surface that absorb moisture and enhance conductivity. However, said absorption of moisture for achieving anti-static effect interferes with properties of the fabric such as wicking and thermal cooling, which are important for breathability of the fabric. Said properties of wicking and thermal cooling are extremely important for the comfort of the wearer especially in the case of garments such as sportswear or uniforms wherein in addition to features such as anti-static and anti-microbial, features such as wicking and thermal cooling of the fabric are also important for purposes of hygiene and comfort. Accordingly, the present invention provides a simple yet effective solution to said problem by providing a fabric coated with the graphene having structural features including combination of single layer and multilayer graphene and having a surface of 300 m²g to 800 m²g as described above that result in one or more of the aforesaid properties optionally along with UV protection.

The present disclosure further relates to the preparation/production of graphene coated fabric. In embodiments of the present disclosure, the production of graphene coated fabric comprises coating graphene and/or its derivatives onto the fabric by techniques such as but not limited to coating and/or dyeing.

Accordingly, the present disclosure further provides a method of preparing a fabric comprising about 0.0001% (w/w) to 1% (w/w) graphene, wherein the graphene is a combination of single layer graphene and multilayer graphene; wherein the graphene has a surface area of about 300 m²g to 800 m²g; and said fabric characterized by one or more features selected from anti-microbial, antistatic, anti-odour, wicking, thermal cooling and ultraviolet protection, the method comprising coating graphene with a fabric.

In some embodiments, the method of preparing the fabric comprising graphene of the present disclosure comprises:
a) preparing a graphene slurry by dispersing graphene in a solvent and optionally a surfactant, followed by mixing to obtain the graphene slurry,
b) mixing the graphene slurry with a dyeing solution to obtain a coating composition, wherein the dyeing solution comprises a disperse dye, a reactive dye, a migration inhibitor, a wetting agent, dispersing agent, sodium bicarbonate, urea, and combinations thereof, and
c) coating a fabric with the coating composition, to prepare the fabric comprising graphene.

In some embodiments of the method of the present disclosure, the method comprises:
a) preparing a graphene slurry by dispersing graphene in water and optionally a surfactant selected from a group comprising polyvinyl pyrrolidone (PVP), sodium dodecyl sulfate (SDS), sodium lauryl sulfate (SLS), sodium lauryl ether sulfate (SLES), silicon and combinations thereof, followed by mixing to obtain the graphene slurry,
b) mixing the graphene slurry with a dyeing solution to obtain a coating composition, wherein the dyeing solution comprises a disperse dye, a reactive dye, a migration inhibitor, a wetting agent, dispersing agent, sodium bicarbonate, urea, and combinations thereof, and
c) coating a fabric with the coating composition to prepare the fabric comprising graphene.

In some embodiments of the method of the present disclosure, the method comprises:
a) preparing a graphene slurry by dispersing graphene in water about 100 RPM to about 10,000 RPM for about 2 hours to 4 hours and optionally a surfactant such as polyvinyl pyrrolidone (PVP) is added prior to dispersing graphene in water, followed by mixing at about 5000 rpm to 7000 rpm for about 10 minutes to 20 minutes to obtain the graphene slurry,
b) mixing the graphene slurry with a dyeing solution to obtain a coating composition, wherein the dyeing solution comprises a disperse dye, a reactive dye, a migration inhibitor, a wetting agent, dispersing agent, sodium bicarbonate, urea, and combinations thereof, and
c) coating a fabric with the coating composition by a dyeing technique selected from the group comprising jigger dyeing, winch dyeing, beam dyeing, padding, pad batch, pad steam, pad dry, thermosol dyeing, soft flow, exhaust dyeing, foam coating and combinations thereof, to prepare the fabric comprising graphene, and
d) drying the fabric comprising graphene in an infra-red pre dryer, followed by drying between 60° C. to 80° C.

In some embodiments of the method of the present disclosure, the method comprises:
a) preparing a graphene slurry by dispersing graphene in water at about 100 RPM to about 10,000 RPM for about 2 hours to 4 hours or adding a surfactant such as polyvinyl pyrrolidone (PVP) to water, and mixing at about 5000 rpm to 7000 rpm for about 10 minutes to 20 minutes, followed by mixing at about 100 RPM to about 10,000 RPM for about 2 hours to 4 to prepare the graphene slurry
b) mixing the graphene slurry with a dyeing solution to obtain a coating composition, wherein the dyeing solution comprises a disperse dye, a reactive dye, a migration inhibitor, a wetting agent, dispersing agent, sodium bicarbonate, urea, and combinations thereof, and
c) coating a fabric with the coating composition with a dyeing technique selected from the group comprising jigger dyeing, winch dyeing, beam dyeing, padding, pad batch, pad steam, pad dry, thermosol dyeing, soft flow, exhaust dyeing, foam coating and combinations thereof, to prepare the fabric comprising graphene,
d) subjecting the fabric coated with coating composition to drying, wherein the drying comprises an initial partial drying in an infra-red pre dryer, followed by final drying between 60° C. to 80° C., and
e) thermo-fixation at about 110° C. to 140° C.

In some embodiments of the method of the present disclosure, the method comprises:
a) preparing the graphene slurry by dispersing graphene in water and mixing for about 3 hours in a high shear mixer,
   or adding polyvinyl pyrrolidone to water and mixing for about 15 minutes at 6000 rpm, followed by dispersing graphene and mixing for about 3 hours in a high shear mixer to prepare the graphene slurry,
b) diluting the graphene slurry with water and filtering through a mesh filter, followed by mixing the graphene slurry with a dyeing solution to obtain a coating composition, wherein the dyeing solution comprises a disperse dye, a reactive dye, a migration inhibitor, a wetting agent, dispersing agent, sodium bicarbonate, urea, and combinations thereof,
c) coating the fabric with the coating composition with a dyeing technique selected from the group comprising, jigger dyeing, winch dyeing, beam dyeing, padding, pad batch, pad steam, pad dry, thermosol dyeing, soft flow, exhaust dyeing, foam coating and combinations thereof, to prepare the fabric comprising graphene,
d) subjecting the fabric coated with coating composition to drying, wherein the drying comprises an initial partial drying in an infra-red pre dryer, followed by final drying between 60° C. to 80° C., and
e) thermo-fixation of the fabric at about 110° C. to 140° C.

In some embodiments of the method of the present disclosure, the method comprises:
a) preparing a graphene slurry by dispersing graphene in water and optionally a surfactant selected from a group comprising polyvinyl pyrrolidone (PVP), sodium dodecyl sulfate (SDS), sodium lauryl sulfate (SLS), sodium lauryl ether sulfate (SLES), silicon and combinations thereof, followed by mixing to obtain the graphene slurry,
b) mixing the graphene slurry with a dyeing solution to obtain a coating composition, wherein the dyeing solution comprises a disperse dye present in an amount of 0.1% to 10% (w/w), including all values or ranges derivable therefrom, a reactive dye present in an amount of 0.1% to 10% (w/w), including all values or ranges derivable therefrom, a migration inhibitor present in an amount of 0.10% to 2% (w/w), including all values or ranges derivable therefrom, a wetting agent present in an amount of 0.1% to 5% (w/w), including all values or ranges derivable therefrom, dispersing agent present in an amount of 0.5% to 5% (w/w), including all values or ranges derivable therefrom, sodium bicarbonate, urea, and combinations thereof, and
c) coating a fabric with the coating composition to prepare the fabric comprising graphene.

In some embodiments of the method of the present disclosure, the method comprises:
a) preparing a graphene slurry by dispersing graphene in water and optionally a surfactant selected from a group comprising polyvinyl pyrrolidone (PVP), sodium dodecyl sulfate (SDS), sodium lauryl sulfate (SLS), sodium lauryl ether sulfate (SLES), silicon and combinations thereof, followed by mixing to obtain the graphene slurry,
b) mixing the graphene slurry with a dyeing solution to obtain a coating composition, wherein the dyeing solution comprises the disperse dye is an azo based dye present in an amount of 1 g/L, the reactive dye is triazine based dye present in an amount of 1 g/L, the migration inhibitor is carboxy methyl cellulose present in an amount of 10 g/L, the wetting agent is sulfonated oil present in an amount of 1 g/L, the dispersing agent is lignin sulphonates present in an amount of 1 g/L, and combinations thereof, and
c) coating a fabric with the coating composition to prepare the fabric comprising graphene.

In some embodiments of the method of the present disclosure, the method comprises:
a) preparing a graphene slurry by dispersing graphene in water and optionally a surfactant selected from a group comprising polyvinyl pyrrolidone (PVP), sodium dodecyl sulfate (SDS), sodium lauryl sulfate (SLS), sodium lauryl ether sulfate (SLES), silicon and combinations thereof, followed by mixing to obtain the graphene slurry,
b) mixing the graphene slurry with a dyeing solution to obtain a coating composition, wherein the dyeing solution comprises the disperse dye is an azo based dye present in an amount of 2 g/L, the reactive dye is triazine based dye present in an amount of 2 g/L, the migration inhibitor is carboxy methyl cellulose present in an amount of 15 g/L, the wetting agent is sulfonated oil present in an amount of 1 g/L, the dispersing agent is lignin sulphonates present in an amount of 5 g/L, sodium bicarbonate present in an amount of 5 g/L, urea present in an amount of 150 g/L, and combinations thereof, and
c) coating a fabric with the coating composition to prepare the fabric comprising graphene.

In some embodiments, the method of preparing the graphene coated fabric of the present disclosure comprises:
a. preparing the graphene slurry;
b. mixing the graphene slurry with a dyeing solution comprising disperse dye, a reactive dye, a migration inhibitor, a wetting agent, dispersing agent, sodium bicarbonate and urea and combinations thereof, to obtain a coating composition; and
c. coating a fabric with a coating composition, to prepare the graphene coated fabric comprising graphene at an amount ranging from about 0.0001% (w/w) to 1% (w/w), wherein the graphene is a combination of single layer graphene and multilayer graphene; wherein the graphene has a surface area of about 300 m²g to 800 m²g; and said fabric is characterized by the combination of at least two features, at least three features, at least four features or all features selected from anti-microbial, antistatic, anti-odour, wicking, thermal cooling and ultraviolet protection.

In some embodiments, the mixing in above steps a) and/or b) is high shear mixing. In some embodiments, the mixing in above steps a) and/or b) is caried out in a high shear mixer.

In some embodiments, the graphene slurry obtained in step a) is a homogenous graphene slurry.

In some embodiments, the solvent is selected from a group comprising water, alcohol, hydrocarbon, organic solvent, inorganic solvent, and combinations thereof. In some embodiments, the solvent is water.

In some embodiments, the surfactant is selected a group comprising polyvinylpyrrolidone (PVP), sodium dodecyl sulfate (SDS), sodium lauryl sulfate (SLS), sodium lauryl ether sulfate (SLES), silicon and combinations thereof. In some embodiments, the surfactant is polyvinylpyrrolidone (PVP).

In some embodiments, the mixing in above steps a) and b) may be conducted by any method routinely practiced in the art that serves the purpose of combining the components.

In exemplary embodiments, the mixing in above step a) is carried out at a mixing rate of about 100 RPM to 10,000 RPM, including all values and ranges therefrom. In some embodiments, the mixing of the graphene slurry and the agent in step b) is carried out at a mixing rate of about 100 RPM to 1000 RPM, including all values and ranges therefrom.

In an embodiment, the prepared graphene slurry is a homogenous slurry or concentrated slurry which is further mixed with dyeing solution as described above to prepare the graphene coating solution which is employed as a graphene source for coating fabric.

In exemplary embodiments, step a) in the above described method comprises preparing the graphene slurry by dispersing the graphene in the solvent and the surfactant followed by mixing to obtain a homogenous or concentrated graphene slurry.

In some embodiments, the ratio between the graphene and the surfactant in the graphene slurry ranges from about 1:20 to 2:1.

In some embodiments, the graphene coating composition is coated to the fabric by one or more dyeing technique selected from a group comprising, jigger dyeing, winch dyeing, beam dyeing, padding, pad batch, pad steam, pad dry, thermosol dyeing, soft flow, exhaust dyeing, foam coating and combinations thereof.

In some embodiments, the graphene coating composition is coated to the fabric by jigger dyeing. In some embodiments, the graphene coating composition is coated to the fabric by winch dyeing. In some embodiments, the graphene coating composition is coated to the fabric by beam dyeing. In some embodiments, the graphene coating composition is coated to the fabric by padding. In some embodiments, the graphene coating composition is coated to the fabric by pad batch. In some embodiments, the graphene coating composition is coated to the fabric by pad steam. In some embodiments, the graphene coating composition is coated to the fabric by pad dry. In some embodiments, the graphene coating composition is coated to the fabric by thermosol dyeing.

In some embodiments, the graphene coating composition is coated to the fabric by soft flow.

In some embodiments, the graphene coating composition is coated to the fabric by exhaust dyeing. In some embodiments, the graphene coating composition is coated to the fabric by foam coating.

The present disclosure also provides for a coating composition for preparing the fabric comprising graphene as described above, comprising: graphene, a solvent, optionally a surfactant, a disperse dye, a reactive dye, a migration inhibitor, a wetting agent, dispersing agent, sodium bicarbonate, and urea; wherein the graphene is a combination of single layer graphene and multilayer graphene; and wherein the graphene has a surface area of about 300 m²g to 800 m²g.

In all embodiments of the coating composition provided herein, the examples of solvent, surfactant, disperse dye, reactive dye, migration inhibitor, wetting agent and dispersing agent of the coating composition is as defined in the above embodiments of method of preparing the fabric comprising graphene. For the sake of brevity and avoiding repetition, each of those embodiments are not being reiterated here again. However, each of the said embodiments, completely fall within the purview of the coating composition.

In some embodiments, the coating composition comprises of the following—
graphene present in an amount of about 0.0001% to 7% (w/w), including all values or ranges derivable therefrom;
a solvent,
optionally, a surfactant present in an amount of about 0.001% to 1% (w/w),
the disperse dye present in an amount of about 0.1% to 10% (w/w), including all values or ranges derivable therefrom;
the reactive dye present in an amount of about 0.1% to 10% (w/w), including all values or ranges derivable therefrom;
the migration inhibitor present in an amount of about 0.10% to 2% (w/w), including all values or ranges derivable therefrom;
the wetting agent present in an amount of about 0.1% to 5% (w/w), including all values or ranges derivable therefrom;
the dispersing agent present in an amount of about 0.5% to 5% (w/w), including all values or ranges derivable therefrom;
sodium bicarbonate, and
urea;
wherein the graphene is a combination of single layer graphene and multilayer graphene;
and wherein the graphene has a surface area of about 300 m²g to 800 m²g.

In some embodiments, the disperse dye is present in the coating composition at a concentration of about 0.1 wt %, about 0.5 wt %, about 1 wt %, about 2 wt %, about 3 wt %, about 4 wt %, about 5 wt %, about 6 wt %, about 7 wt %, about 8 wt %, about 9 wt % or about 10 wt %.

In some embodiments, the reactive dye is present in the coating composition at a concentration of about 0.1 wt %, about 0.5 wt %, about 1 wt %, about 2 wt %, about 3 wt %, about 4 wt %, about 5 wt %, about 6 wt %, about 7 wt %, about 8 wt %, about 9 wt % or about 10 wt %.

In some embodiments, the migration inhibitor is present in the coating composition at a concentration of about 0.1 wt %, about 0.5 wt %, about 1.0 wt %, about 1.5 wt %, or about 2.0 wt %.

In some embodiments, the wetting agent is present in the coating composition at a concentration of about 0.1 wt %, about 0.5 wt %, about 1 wt %, about 1.5 wt %, about 2 wt %, about 2.5 wt %, about 3 wt %, about 3.5 wt %, about 4 wt %, about 4.5 wt %, or about 5 wt %.

In some embodiments, the dispersing agent is present in the coating composition at a concentration of about 0.5 wt %, about 1 wt %, about 1.5 wt %, about 2 wt %, about 2.5 wt %, about 3 wt %, about 3.5 wt %, about 4 wt %, about 4.5 wt %, about 5 wt %.

In some embodiments, the graphene coating composition comprises graphene at a concentration of about 0.0001 wt % to 7 wt % or 0.001 wt % to 7 wt % or 0.01 wt % to 7 wt % or 0.1 wt % to 7 wt %, wherein about 80% to about 85% of graphene is single layer graphene, and about 15% to about 20% of graphene is multilayer graphene, wherein the multi-layer graphene comprises of about 2 to about 5 layers of graphene.

In some embodiments, the graphene coating composition comprises graphene at a concentration of about 0.5 wt % to 7 wt % or 1 wt % to 7 wt % or 1 wt % to 2 wt % or 0.1 wt % to 0.5 wt %, wherein about 80% to about 85% of graphene is single layer graphene, and about 15% to about 20% of graphene is multilayer graphene, and wherein the multi-layer graphene comprises of about 2 to about 5 layers of graphene.

In some embodiments, the graphene coating composition comprises graphene at a concentration of about 0.0001 wt %, 0.001 wt %, 0.01 wt %, 0.1 wt %, about 0.5%, about 1 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt % or about 7 wt %, wherein about 80% to about 85% of graphene is single layer graphene, and about 15% to about 20% of graphene is multilayer graphene, and wherein the multi-layered graphene comprises of about 2 to about 5 layers of graphene.

In some embodiments, the graphene coating composition is prepared to comprise graphene at a concentration higher than that at which it is present in the final fabric. Once the composition is prepared and applied/coated to the fabric and said fabric is processed as explained in the present disclosure, the final fabric obtained comprises graphene at a concentration of about 0.0001 wt % to 1 wt %, as defined herein.

In some embodiments, the coating composition comprises of the following—
graphene present in an amount of about 0.0001% to 7% (w/w), including all values or ranges derivable therefrom;
water,
polyvinyl pyrrolidone (PVP) present in an amount of about 0.001% to 1% (w/w), including all values or ranges derivable therefrom,
azo based dye present in an amount of about 0.1% to 10% (w/w), including all values or ranges derivable therefrom;
triazine based dye present in an amount of about 0.1% to 10% (w/w), including all values or ranges derivable therefrom;
carboxy methyl cellulose present in an amount of about 0.10% to 2% (w/w), including all values or ranges derivable therefrom;
sulfonated oil present in an amount of about 0.1% to 5% (w/w), including all values or ranges derivable therefrom; and
lignin sulphonates present in an amount of about 0.5% to 5% (w/w), including all values or ranges derivable therefrom;
sodium bicarbonate, and
urea;
wherein the graphene is a combination of single layer graphene and multilayer graphene;
and wherein the graphene has a surface area of about 300 m²g to 800 m²g.

In some embodiments, the coating composition comprises of the following—
graphene present in an amount of about 0.0001% to 7% (w/w), including all values or ranges derivable therefrom;
water,
polyvinyl pyrrolidone (PVP),
azo based dye present in an amount of 1 g/L;
triazine based dye present in an amount of 1 g/L;
carboxy methyl cellulose present in an amount of 10 g/L;
sulfonated oil present in an amount of 1 g/L;
lignin sulphonates present in an amount of 1 g/L;
sodium bicarbonate; and
urea;
wherein the graphene is a combination of single layer graphene and multilayer graphene;
and wherein the graphene has a surface area of about 300 m²g to 800 m²g.

In some embodiments, the coating composition comprises of the following—
graphene present in an amount of about 0.0001% to 7% (w/w), including all values or ranges derivable therefrom;
water,
polyvinyl pyrrolidone (PVP),
azo based dye present in an amount of 2 g/L;
triazine based dye present in an amount of 2 g/L;
carboxy methyl cellulose present in an amount of 15 g/L;
sulfonated oil present in an amount of 1 g/L;
lignin sulphonates present in an amount of 5 g/L;
sodium bicarbonate present in an amount of about 5 g/L; and
urea present in an amount of about 150 g/L;
wherein the graphene is a combination of single layer graphene and multilayer graphene;
and wherein the graphene has a surface area of about 300 m²g to 800 m²g.

In some embodiments, the coating composition is prepared by:
a) preparing a graphene slurry; and
b) mixing the graphene slurry with a dyeing solution to obtain a coating composition.

In some embodiments of the present disclosure, the preparation of the graphene coating composition comprises
a) dispersing graphene in a solvent and optionally along with a surfactant, in a high shear mixer, to prepare a homogenous graphene slurry,
b) mixing the graphene slurry with a dyeing solution comprising but not limited to a disperse dye, a reactive dye, a migration inhibitor, a wetting agent, dispersing agent, sodium bicarbonate, urea and combinations thereof, to obtain a coating composition.

In some embodiments, the coating composition is prepared by:
a) dispersing graphene in water and optionally a surfactant such as PVP followed by mixing in a high shear mixer, to prepare the graphene slurry; and mixing the graphene slurry with a dyeing solution to obtain a coating composition, wherein the dyeing solution comprises a disperse dye, a reactive dye, a migration inhibitor, a wetting agent, dispersing agent, sodium bicarbonate, urea and combinations thereof.

The present disclosure also relates to a kit for preparing the graphene coated fabric as described above, comprising
a graphene slurry comprising graphene, solvent and optionally, a surfactant; and
a dyeing solution comprising a disperse dye, a reactive dye, a migration inhibitor, a wetting agent, dispersing agent, sodium bicarbonate and urea;
   wherein the graphene is a combination of single layer graphene and multilayer graphene, and wherein the graphene has a surface area of about 300 m²g to 800 m²g.

In some embodiments, the kit for preparing the graphene coated fabric as described above, comprises
a graphene slurry comprising graphene, solvent and optionally, a surfactant, and
a dyeing solution comprising a disperse dye, a reactive dye, a migration inhibitor, a wetting agent, dispersing agent, sodium bicarbonate and urea;
   wherein the graphene is a combination of single layer graphene and multilayer graphene, wherein about 80% of the graphene is a single layer graphene and about 20% is a multilayer graphene; and wherein the graphene has a surface area of about 300 m²g to 800 m²g.

In some embodiments, the kit for preparing the graphene coated fabric as described above, comprises
a graphene slurry comprising graphene, solvent and optionally, a surfactant; and
a dyeing solution comprising a disperse dye, a reactive dye, a migration inhibitor, a wetting agent, dispersing agent, sodium bicarbonate and urea;
   wherein the graphene is a combination of single layer graphene and multilayer graphene, wherein about 80% of the graphene is a single layer graphene and about 20% is a multilayer graphene, wherein the multilayer graphene comprises two layers to five layers of graphene, preferably two-layer graphene or three-layer graphene or a combination thereof; and wherein the graphene has a surface area of about 400 m²g to 500 m²g.

In all embodiments of the kit provided herein, the examples of solvent, surfactant, disperse dye, reactive dye, migration inhibitor, wetting agent and dispersing agent of the kit is as defined in the above embodiments of method of preparing the fabric comprising graphene. For the sake of brevity and avoiding repetition, each of those embodiments are not being reiterated here again. However, each of the said embodiments, completely fall within the purview of said kit.

The present disclosure also relates to a dyeing solution for preparing the coating composition as described above, comprising: a disperse dye, a reactive dye, a migration inhibitor, a wetting agent, a dispersing agent, sodium bicarbonate, and urea.

In all embodiments of the dyeing solution provided herein, the examples of disperse dye, reactive dye, migration inhibitor, wetting agent and dispersing agent of the dyeing solution is as defined in the above embodiments of method of preparing the fabric comprising graphene. For the sake of brevity and avoiding repetition, each of those embodiments are not being reiterated here again. However, each of the said embodiments, completely fall within the purview of said dyeing solution.

In some embodiments, when present in the dyeing solution, the disperse dye is in an amount of about 0.1% to 10% (w/w), the reactive dye is in an amount of about 0.1% to 10% (w/w), the migration inhibitor is in an amount of about 0.1% to 2% (w/w), the wetting agent is in an amount of about 0.1% to 5% (w/w), and the dispersing agent is in an amount of about 0.5% to 5% (w/w), sodium bicarbonate, urea, including all values or ranges derivable therefrom.

In some embodiments, the dyeing solution for preparing the coating composition as described above comprises:
a) the disperse dye is azo based dye is present in an amount of 0.1% to 10% (w/w), including all values or ranges derivable therefrom;
b) the reactive dye is triazine based dye is present in an amount of 0.1% to 10% (w/w), including all values or ranges derivable therefrom;
c) the migration inhibitor is carboxy methyl cellulose and is present in an amount of 0.1% to 2% (w/w), including all values or ranges derivable therefrom;
d) the wetting agent is sulfonated oil and is present in an amount of 0.1% to 5% (w/w), including all values or ranges derivable therefrom; and
e) the dispersing agent is lignin sulphonates and is present in an amount of 0.5% to 5% (w/w), including all values or ranges derivable therefrom;
f) sodium bicarbonate; and
g) urea.

In some embodiments, the dyeing solution for preparing the coating composition as described above comprises:
a) azo based dye present in an amount of 1 g/L;
b) triazine based dye present in an amount of 1 g/L;
c) carboxy methyl cellulose present in an amount of 10 g/L;
d) sulfonated oil present in an amount of 1 g/L;
e) lignin sulphonates present in an amount of 1 g/L.

In some embodiments, the dyeing solution for preparing the coating composition as described above comprises:
a) an azo based dye present in an amount of 2 g/L;
b) triazine based dye present in an amount of 2 g/L;
c) sodium bicarbonate present in an amount of 5 g/L;
d) urea present in an amount of 150 g/L;
e) carboxy methyl cellulose present in an amount of 15 g/L;
f) sulfonated oil present in an amount of 1 g/L;
g) lignin sulphonates present in an amount of 5 g/L.

In some embodiments, the methods of the present disclosure and described variants thereof coat the graphene on the surface of the fabric. The fabric obtained by the aforesaid method retains the anti-microbial, antistatic, anti-odour, wicking, thermal cooling and ultraviolet protection features after 30 washes or more, preferably at least about 50 washes, more preferably until entire life of the fabric.

In some embodiments of the present disclosure, the preparation/production of graphene coated fabric is achieved by a one-step industrially adapted large-scale mass production dyeing process without the involvement of post processing techniques.

In some embodiments of the present disclosure, the graphene is coated during synthesis/production of fabrics. In other embodiments of the present disclosure, the graphene is coated onto the synthesized/produced fabrics or virgin fabrics.

In some embodiments, the graphene coating solution is coated or dyed onto the fabric by continuous dyeing.

In some embodiments, the graphene coating solution is coated or dyed onto the fabric by exhaust dyeing or batch dyeing.

In some embodiments, the graphene coating solution is coated or dyed using a stenter.

In some embodiments, the graphene coating solution is coated or dyed onto the fabric by a combination of continuous dyeing, exhaust dyeing or batch dyeing, and by a stenter.

The present disclosure further relates to use of graphene for preparing a graphene coated fabric comprising graphene at an amount ranging from about 0.0001 to 1% (w/w), wherein the graphene is a combination of single layer graphene and multilayer graphene and the graphene has a surface area of about 300 m²g to 800 m²g, and said fabric is characterized by a combination of one or more features selected from anti-microbial, antistatic, anti-odour, wicking, thermal cooling and ultraviolet protection. In some embodiments, said graphene coated fabric is characterized by a combination of all features—anti-microbial, antistatic, anti-odour, wicking, thermal cooling and ultraviolet protection.

In some embodiments, the use comprises preparing a graphene coating composition comprising graphene at a concentration higher than that at which it is present in the final fabric and applying/coating said coating composition to the fabric. Once the graphene coating composition is prepared and applied/coated to the fabric and said fabric is processed as explained in the present disclosure, the resulting final fabric comprises graphene at a concentration of about 0.0001 wt % to 1 wt %, as defined herein. In some embodiments, the aforesaid use comprises preparing a coating composition comprising graphene an amount ranging from about 0.0001 wt % to 7 wt % along with other components of dyeing solution as described herein, followed by its application to the fabric to yield a fabric comprising graphene at an amount ranging from about 0.0001 to 1% (w/w).

As mentioned above, the graphene in the aforesaid use is a graphene, a graphene derivative or a combination thereof.

The present disclosure further provides use of the graphene coated fabric in applications/manufacture of commercial products such as but not limited to textile products in medical applications/hospitals such as aprons, garments, furniture covers, bed covers, pillow covers, curtains, other apparels, upholstery, carpets and bags.

To solve the need in the art for improved fabrics with multiple beneficial features, the present disclosure provides fabric coated with graphene, said graphene having specific structural features including: a) the graphene being a combination of single layer graphene and multilayer graphene, b) the graphene having a surface area of about 300 m²g to 800 m²g, and c) the graphene being present in the fabric at very low concentrations of 0.0001% (w/w) to 1% (w/w). Advantages of the graphene coated fabric of the present disclosure include but are not limited to—
beneficial properties at very low concentrations of specific graphene and/or its derivatives described herein;
very good/excellent washing fastness, rubbing fastness, perspiration fastness, sublimation fastness and light fastness;
retention of the beneficial properties discussed above along with excellent washing, rubbing, perspiration, sublimation and light fastness features even after multiple washes of the fabric thus providing excellent stability to the fabric after repeated washing cycles;
enhanced anti-microbial, antistatic, anti-odour, wicking, thermal cooling and ultraviolet protection as compared to unprocessed/graphene lacking fabrics;
retaining anti-microbial, antistatic, anti-odour, wicking, thermal cooling and ultraviolet protection till the life of the fabric; economical, repeatable and commercially/industrially viable process for production. Particularly, the graphene coating can be provided onto the fabric at the finishing stage of fabric processing, and is a one-step industrially adapted large scale mass production process;
avoiding use of numerous additives/agents to provide all the features anti-microbial, antistatic, anti-odour, wicking, thermal cooling and ultraviolet protection, wherein employing different/multiple additives/agents lead to additional processing steps, costs, manpower and time. Thus, by coating the fabric with very low amounts of specific graphene as described herein, additional processing steps required to achieve all the above mentioned features is avoided.

While the present disclosure is susceptible to various modifications and alternative forms, specific aspects thereof have been shown by way of examples and drawings and are described in detail below. However, it should be understood that it is not intended to limit the invention to the particular forms disclosed, but on the contrary, the intention is to cover all modifications, equivalents, and alternatives falling within the spirit and the scope of the invention as defined by the appended claims.

### EXAMPLES

The present disclosure is further described with reference to the following examples, which are only illustrative in nature and should not be construed to limit the scope of the present disclosure in any manner.

### Example 1: Preparation of Graphene Slurry

A water-based graphene slurry was prepared using high shear mixer. 1 kg multilayer graphene of surface area of 450 m²/g was dispersed in 48.8 kg water for 3 hours using high shear mixer to obtain a homogeneous and concentrated graphene slurry. 0.2 kg PVP (polyvinyl pyrrolidone) surfactant was added in the said amount of water and was mixed for 15 minutes at 6000 RPM prior to the graphene addition step.

### Example 2: Preparation of Coating Composition

1 kg of above prepared graphene slurry was diluted 5 times with water and stirred. The slurry was then filtered two times through a 55-micron mesh filter and required amount of graphene slurry is mixed with the dyeing solution 1 or dyeing solution 2 to obtain a coating composition.

Dyeing solution 1 comprises of the following components:
a disperse dye which is an azo based dye—1 g/L
a reactive dye which is a triazine based dye—1 g/L
migration inhibitor which is carboxy methyl cellulose—10 g/L
wetting agent which is sulfonated oil—1 g/L
dispersing agent which is lignin sulphonates—1 g/L

Dyeing solution 2 comprises of the following components:
a disperse dye which is an azo based dye—2 g/L
a reactive dye which is a triazine based dye—2 g/L
sodium bicarbonate—5 g/L
urea—150 g/L
migration inhibitor is carboxy methyl cellulose—15 g/L
wetting agent is sulfonated oil—1 g/L
dispersing agent is lignin sulphonates—5 g/L

### Example 3: Preparation of Graphene Coated Fabric

The coating composition prepared in Example 2 was used for coating of the 100 kg cotton fabric. The coating of the fabric was carried out at room temperature and was performed by known pad dry cure method

After coating, an initial partial drying was carried out in an infrared pre dryer to avoid migration of dyes followed by final drying at 80° C. After drying, thermo-fixation was carried out at 110-140° C. The graphene coated cotton fabric obtained by this process comprises graphene at a concentration of about 0.02 wt % (w/w) with respect to the weight of the fabric.

### Example 4: Effect of Graphene Coating on Static Charge Discharge, Moisture Absorbency and UV Protection Properties of Fabrics

The graphene coated cotton fabric of the present disclosure (as described in Example 3) comprising graphene at a concentration of about 0.02 wt % (w/w) with respect to the weight of the fabric was tested for various properties. The graphene coated fabric of the present invention showed half decay time for discharge of charge applied on the substrate surface that is 0.58 s. Moreover, the said graphene coated fabric showed moisture absorbency of 1.09 s as per AATCC 79 test method. The graphene coated fabric was also characterized by means UV protection factor which was 45.15 as per AATCC 183-2014 test method. The said graphene coated fabric of the present disclosure showed 6.5 inches in 30 minutes of vertical moisture wicking according to AATCC197:2013.

### Example 5: Effect of Graphene Coating on Thermal Cooling, Antibacterial and Antiviral Properties of Fabrics

The graphene coated cotton fabric of the present disclosure as described in Example 2 comprising graphene at a concentration of 0.02 wt % with respect to the weight of the fabric is further characterized by the thermal cooling property which was measured by Q-Max and showed 0.18 W/cm² (dry) and 0.58 W/cm²(wet) as per KAWABATA System using KES-F7 Instruction.

The said graphene coated fabric showed 99.61% bactericidal activity against Staphylococcus aureus and Klebsiella pneumonia as per AATCC 100-2019 test method. The graphene coated fabric was also characterized by antiviral effect and exhibited 99.9% antiviral activity against MS2 bacteriophage as per AATCC 100-2012 test method. The above results are summarized in Table 2 as follows:

TABLE 2
Analysis of features of the graphene coated fabric

| Feature | | | Observation | | Pass/ |
|---|---|---|---|---|---|
| Required | Standard | Standard values | on Fabric | Inferences | Fail |
| Anti-static | ASTM D: | <2S Half Decay | 0.58S | Good | Pass |
| | 4238:90 | time | | antistatic | |
| | | | | behaviour | |
| Antibacterial | JIS L 1902- | 99-Fair; | Sa-99.16% | Very good | Pass |
| | Bactericidal | >99.5-Very good; | Kp-99.16% | bactericidal | |
| | Act. | 99.99-Excellent | | behaviour | |
| | | Sa- | | | |
| | | Staphylococcus | | | |
| | | aureus | | | |
| | | Kp-Klebsiella | | | |
| | | pneumonia | | | |
| | | Ec-Escherichia | | | |
| | | coli | | | |
| Anti-viral | AATCC | Log reduction of | 99.9% | Excellent | Pass |
| | 100-2012 | Virus > 3.5 | | antiviral | |
| | | M2 | | behaviour | |
| | | bacteriophage | | | |
| Anti-odour | AATCC100 | | | | Pass |
| Wicking | — | NA | 6.5 inches/ | Good | Pass |
| | | | 30 minutes | | |
| UV | AATCC 183 | 25-35-good UV | 45.15 | Good UV | Pass |
| protection | | protection; | | protection | |
| | | ≥50-excellent | | | |
| | | UV protection | | | |
| Thermal | Kawabata | 0.11 W/cm² | 0.18 W/cm² | Good | Pass |
| cooling | KES-F7 | Dry state | (dry) | thermal | |
| | | 0.24 W/cm² | 0.58 W/cm² | cooling | |
| | | Wet state | (wet) | | |
| Moisture | AATCC 79 | 4.87 S-Control | 1.09 S | Excellent | Pass |
| absorbency | | | | absorbency | |
| | | | | of water | |

Additional embodiments and features of the present disclosure will be apparent to one of ordinary skill in art based on the description provided herein. The embodiments herein provide various features and advantageous details thereof in the description. Descriptions of well-known/conventional methods and techniques are omitted so as to not unnecessarily obscure the embodiments herein.

The foregoing description of the specific embodiments fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments in this disclosure have been described in terms of preferred embodiments, those skilled in the art will recognize that the embodiments herein can be practiced with modification within the spirit and scope of the embodiments as described herein.

Throughout this specification, the word “comprise”, or variations such as “comprises” or “comprising” wherever used, will be understood to imply the inclusion of a stated element, integer or step, or group of elements, integers or steps, but not the exclusion of any other element, integer or step, or group of elements, integers or steps. The term “about” is used herein to mean approximately, in the region of, roughly, or around. When the term “about” is used in conjunction with a numerical value/range, it modifies that value/range by extending the boundaries above and below the numerical value(s) set forth. In general, the term “about” is used herein to modify a numerical value(s) above and below the stated value(s) by a variance of 10%.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

As regards the embodiments characterized in this specification, it is intended that each embodiment be read independently as well as in combination with another embodiment. For example, in case of an embodiment 1 reciting 3 alternatives A, B and C, an embodiment 2 reciting 3 alternatives D, E and F and an embodiment 3 reciting 3 alternatives G, H and I, it is to be understood that the specification unambiguously discloses embodiments corresponding to combinations A, D, G; A, D, H; A, D, I; A, E, G; A, E, H; A, E, I; A, F, G; A, F, H; A, F, I; B, D, G; B, D, H; B, D, I; B, E, G; B, E, H; B, E, I; B, F, G; B, F, H; B, F, I; C, D, G; C, D, H; C, D, I; C, E, G; C, E, H; C, E, I; C, F, G; C, F, H; C, F, I, unless specifically mentioned otherwise.

Any discussion of documents, acts, materials, devices, articles and the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

While considerable emphasis has been placed herein on the particular features of this disclosure, it will be appreciated that various modifications can be made, and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

All references, articles, publications, general disclosures etc. cited herein are incorporated by reference in their entireties for all purposes. However, mention of any reference, article, publication etc. cited herein is not, and should not be taken as, an acknowledgment or any form of suggestion that they constitute valid prior art or form part of the common general knowledge in any country in the world.

1. A fabric comprising graphene,
wherein an amount of the graphene in the fabric is about 0.0001% (w/w) to 1% (w/w),
wherein the graphene is a combination of a single layer graphene and a multilayer graphene,
wherein the graphene has a surface area of about 300 m²/g to 800 m²/g
wherein said fabric is characterized by features selected from antimicrobial, antistatic, anti-odor, wicking, thermal cooling, ultraviolet (UV) protection, or any combination of features thereof.

2. The fabric as claimed in claim 1, wherein the graphene comprises about 80% to 85% of the single layer graphene and about 15% to 20% of the multilayer graphene;
or wherein the multilayer graphene comprises two to five layers of graphene or a combination thereof;
or wherein the graphene has a surface area of about 400 m²/g to 500 m²/g.

3. The fabric as claimed in claim 1, wherein the graphene is present at an amount ranging from about 0.0001% (w/w) in the fabric; or
wherein the graphene is present in the fabric in the form of a coat on the surface of the fabric.

4. The fabric as claimed in claim 1, wherein the fabric is selected from the group consisting of natural fabric, synthetic fabric, a blend of natural fabric and synthetic fabric, and combinations thereof.

5. The fabric as claimed in claim 1, wherein the fabric is a cotton fabric or a cotton polyester blend.

6. The fabric as claimed in claim 1, wherein the fabric is characterized by:
a) one or more, or a combination of at least two, at least three, at least four or at least five features selected from antimicrobial, antistatic, anti-odour, wicking, thermal cooling and ultraviolet protection; or
b) an increase of 1 fold to 10 fold of antimicrobial, antistatic, anti-odour, wicking, thermal cooling and ultraviolet protection features when compared to a fabric lacking graphene; or
c) bactericidal or antibacterial effect, bacteriostatic effect, antiviral effect, or combinations thereof; wherein the fabric is characterized by a bactericidal effect ranging from about 90% to 99.999% against Staphylococcus aureus, Klebsiella pneumonia, and Escherichia coli; wherein the fabric is characterized by a bacteriostatic effect ranging from about 90% to 99.999% against Staphylococcus aureus, Klebsiella pneumonia, and Escherichia coli; wherein the fabric is characterized by an antiviral effect ranging from about 90% to 99.999% against MS2 bacteriophage; or
d) antistatic effect measured by half decay time for discharge of charge applied on the fabric surface which ranges from about 0.1 seconds to 3 seconds, thermal cooling measured by Q-Max which ranges from about 0.1 watts per square centimeter (W/cm²) to 0.7 W/cm², and ultraviolet protection measured by ultraviolet protection factor (UPF) which ranges from about 30 to 70.

7. A method of preparing the fabric comprising graphene as claimed in claim 1, said method comprising:
a) preparing a graphene slurry by dispersing graphene in a solvent and optionally a surfactant, followed by mixing to obtain the graphene slurry;
b) mixing the graphene slurry with a dyeing solution to obtain a coating composition, wherein the dyeing solution comprises a disperse dye, a reactive dye, a migration inhibitor, a wetting agent, dispersing agent, sodium bicarbonate, and urea; and
c) coating a fabric with the coating composition, to prepare the fabric comprising graphene.

8. The method as claimed in claim 7, wherein:
a) the graphene is employed at an amount of about 0.01% to 7% (w/w), for preparing the graphene slurry in said a);
b) the graphene is present as a coat on the fabric in an amount ranging from about 0.0001% (w/w) to 1% (w/w);
c) the graphene is a combination of single layer graphene and multilayer graphene, wherein about 80% to 85% of the graphene is single layer graphene and about 15% to 20% is multilayer graphene;
d) the multilayer graphene comprises two layers to five layers of graphene, preferably two-layer graphene or three-layer graphene or a combination thereof; and
e) the graphene has a surface area of about 300-800 m²/g, preferably about 400-500 m²/g.

9. The method as claimed in claim 7, wherein the solvent is selected from the group consisting of water, alcohol, hydrocarbon, organic solvents, inorganic solvents, and combinations thereof;
and wherein the surfactant is selected from the group consisting of polyvinyl pyrrolidone (PVP), sodium dodecyl sulfate (SDS), sodium lauryl sulfate (SLS), sodium lauryl ether sulfate (SLES), silicon, and combinations thereof.

10. The method as claimed in claim 7, wherein the mixing in said a) or said b) is carried out at a mixing rate of about 100 RPM to about 10,000 RPM for about 2 hours to 4 hours.

11. The method as claimed in claim 7, wherein the surfactant is mixed with the solvent before dispersing the graphene, and wherein said mixing is carried out at about 5000 rpm to 7000 rpm for about 10 minutes to 20 minutes.

12. The method as claimed in claim 7, wherein the fabric is coated with the coating composition by a dyeing technique selected from the group consisting of jigger dyeing, winch dyeing, beam dyeing, padding, pad batch, pad steam, pad dry, thermosol dyeing, soft flow, exhaust dyeing, foam coating, and combinations thereof.

13. The method as claimed in claim 7, further comprising subjecting the fabric coated with the coating composition to drying, wherein the drying comprises an initial partial drying in an infra-red pre dryer, followed by final drying between 60° C. to 80° C. and further comprising thermo-fixation carried out at about 110° C. to 140° C.

14. The method as claimed in claim 7, wherein the method comprises:
a) preparing the graphene slurry by dispersing graphene in water and mixing for about 3 hours in a high shear mixer,
or adding polyvinyl pyrrolidone to water and mixing for about 15 minutes at 6000 rpm, followed by dispersing graphene and mixing for about 3 hours in a high shear mixer to prepare the graphene slurry;
b) diluting the graphene slurry with water and filtering through a mesh filter, followed by mixing the graphene slurry with the dyeing solution to obtain a coating composition, wherein the dyeing solution comprises a disperse dye, a reactive dye, a migration inhibitor, a wetting agent, dispersing agent, sodium bicarbonate, and urea;
c) coating the fabric with the coating composition, to prepare the fabric comprising graphene;
d) subjecting the fabric coated with the coating composition to drying, wherein the drying comprises an initial partial drying in an infra-red pre dryer, followed by final drying between 60° C. to 80° C.; and
e) thermo-fixation of the fabric at about 110° C. to 140° C.

15. A coating composition for preparing the fabric comprising graphene as claimed in claim 1, comprising:
graphene present in an amount of about 0.0001% to 7% (w/w),
a solvent,
optionally, a surfactant present in an amount of about 0.001% to 1% (w/w),
a disperse dye present in an amount of about 0.1% to 10% (w/w),
a reactive dye present in an amount of about 0.1% to 10% (w/w),
a migration inhibitor present in an amount of about 0.1% to 2% (w/w),
a wetting agent present in an amount of about 0.1% to 5% (w/w),
dispersing agent present in an amount of about 0.5% to 5% (w/w),
sodium bicarbonate, and
urea.

16. A kit for preparing the fabric comprising graphene as claimed in claim 1, comprising:
a graphene slurry comprising graphene, solvent and optionally, a surfactant; and
a dyeing solution comprising a disperse dye, a reactive dye, a migration inhibitor, a wetting agent, dispersing agent, sodium bicarbonate, and urea.

17. The coating composition as claimed in claim 15, wherein:
a) the graphene comprises about 80% to 85% of the single layer graphene and about 15% to 20% of the multilayer graphene;
b) the multilayer graphene comprises two layers to five layers of graphene, preferably two-layer graphene or three-layer graphene or a combination thereof, and
c) the graphene has a surface area of 300-800 m²/g, preferably 400-500 m²/g.

18. The kit as claimed in claim 16, wherein:
a) the graphene comprises about 80% to 85% of the single layer graphene and about 15% to 20% of the multilayer graphene;
b) the multilayer graphene comprises two layers to five layers of graphene, preferably two-layer graphene or three-layer graphene or a combination thereof, and
c) the graphene has a surface area of 300-800 m²/g, preferably 400-500 m²/g.

19. The fabric of claim 2, wherein the multilayer graphene comprises a two-layer graphene or a three-layer graphene or a combination thereof.

20. The fabric of claim 3, wherein the amount of the graphene in the fabric is from 0.0001% (w/w) to 0.004% (w/w).
